(19) United States
(12) Patent Application Publication
(10) Pub. No.: US 2025/0371802 A1
(43) Pub. Date: Dec. 4, 2025

(54) PAGE PROCESSING METHOD AND APPARATUS, AND ELECTRONIC DEVICE

(71) Applicant: TENCENT TECHNOLOGY (SHENZHEN) COMPANY LIMITED, SHENZHEN (CN)

(72) Inventors: Sha SHA, SHENZHEN (CN); Yang ZENG, SHENZHEN (CN); Liqiang LIU, SHENZHEN (CN); Xianmin XIAO, SHENZHEN (CN)

(73) Assignee: TENCENT TECHNOLOGY (SHENZHEN) COMPANY LIMITED, SHENZHEN (CN)

(21) Appl. No.: 19/303,625

(22) Filed: Aug. 19, 2025

Related U.S. Application Data
(63) Continuation of application No. PCT/CN2024/111364, filed on Aug. 12, 2024.

(30) Foreign Application Priority Data
Aug. 31, 2023 (CN) 202311131255.7

(51) Int. Cl. G06T 17/00; G06Q 50/00; G06T 13/40

(52) U.S. Cl. CPC G06T 17/00; G06Q 50/01; G06T 13/40

(57) ABSTRACT

The present disclosure relates to the field of computer technologies, and in particular, to a page processing method and apparatus, and an electronic device. In some embodiments, in response to a trigger operation performed by a target object on multimedia content, a multimedia content presentation page is generated and presented, the multimedia content presentation page including a presentation area and an interaction area of the multimedia content; in the interaction area, interaction information of at least one interaction object performing an interactive operation on the multimedia content is rendered; interaction information of each interaction object includes: a virtual figure of the interaction object, and interaction content generated by the interaction object by performing an interactive operation on the multimedia content; and the interaction content is presented within a peripheral range of the virtual figure of the interaction object.

### RELATED APPLICATION

This application is a continuation application of PCT Patent Application No. PCT/CN2024/111364, filed on Aug. 12, 2024, which claims priority to and is based on Chinese Patent Application No. 202311131255.7, filed on Aug. 31, 2023, both of which are incorporated herein by reference in their entireties.

### FIELD OF THE TECHNOLOGY

The present disclosure relates to the field of computer technologies, and in particular, to a page processing method and apparatus, and an electronic device.

### BACKGROUND OF THE DISCLOSURE

With the development of Internet technologies, an increasing quantity of objects publish multimedia content online, and an increasing quantity of objects publish their comments under multimedia content.

In some methods, for multimedia content, comments published by different objects are generally presented in a preset arrangement manner. The foregoing arrangement manner may be flexibly configured based on a use requirement. For example, the comments published by different objects may be arranged based on a sequence of publication time. For another example, the comments published by different objects may be arranged based on popularity of the published comments.

The present disclosure describes various embodiments for processing presentation pages, addressing at least one of the problems/issues in the present fields, increasing a recognition degree of comments published by different objects, reducing time of searching for a comment by a target object, improving efficiency of searching for a comment by a target object, improving efficiency of interaction result searching, improving efficiency of viewing the interaction information by a target object, and/or improving use experience. Thus, the present disclosure improves the field of computer technologies, particularly related to social medium and social network.

### SUMMARY

An objective of the present disclosure is to provide a page processing method and apparatus, and an electronic device, to increase a recognition degree of comments published by different objects, reduce time of searching for a comment by a target object, and improve efficiency of searching for a comment by the target object.

Embodiments of the present disclosure provide a page processing method, the method including:
generating and presenting a multimedia content presentation page in response to a trigger operation performed by a target object on multimedia content, the multimedia content presentation page including a presentation area and an interaction area of the multimedia content; and
rendering, in the interaction area, interaction information of at least one interaction object performing an interactive operation on the multimedia content, interaction information of each interaction object including: a virtual figure of the interaction object, and interaction content generated by the interaction object by performing the interactive operation on the multimedia content, where the interaction content is presented within a peripheral preset range of the virtual figure of the interaction object.

Embodiments of the present disclosure further provide another page processing method, the method including:
receiving a content obtaining request sent by a client and determining initial page content of a multimedia content presentation page, the content obtaining request being sent when the client detects a trigger operation performed by a target object on multimedia content;
sending the initial page content to the client; and
receiving an initial virtual figure obtaining request replied by the client, determining a corresponding initial virtual figure, and sending the corresponding initial virtual figure to the client, to make the client generate and present the multimedia content presentation page based on the initial virtual figure and with reference to the initial page content, the multimedia content presentation page including: a presentation area and an interaction area of the multimedia content, and rendering, in the interaction area, interaction information of at least one interaction object performing an interactive operation on the multimedia content; the interaction information of each interaction object including: a virtual figure of the interaction object, and interaction content generated by the interaction object by performing the interactive operation on the multimedia content, where the interaction content is presented within a peripheral range of the virtual figure of the interaction object.

Embodiments of the present disclosure further provide a page processing apparatus, including:
a render module, configured to generate and present a multimedia content presentation page in response to a trigger operation performed by a target object on multimedia content, the multimedia content presentation page including a presentation area and an interaction area of the multimedia content; and
an interaction module, configured to render, in the interaction area, interaction information of at least one interaction object performing an interactive operation on the multimedia content, interaction information of each interaction object including: a virtual figure of the interaction object, and interaction content generated by the interaction object by performing the interactive operation on the multimedia content, where the interaction content is presented within a peripheral preset range of the virtual figure of the interaction object.

Embodiments of the present disclosure further provide another page processing apparatus, including:
a receiving module, configured to receive a content obtaining request sent by a client and determine initial page content of a multimedia content presentation page, the content obtaining request being sent when the client detects a trigger operation performed by a target object on multimedia content;
a sending module, configured to send the initial page content to the client; and
a determining module, configured to receive an initial virtual figure obtaining request replied by the client, determine a corresponding initial virtual figure, and send the corresponding initial virtual figure to the client, to make the client generate and present the multimedia content presentation page based on the initial virtual figure and with reference to the initial page content, the multimedia content presentation page including: a presentation area and an interaction area of the multimedia content, and rendering, in the interaction area, interaction information of at least one interaction object performing an interactive operation on the multimedia content; interaction information of each interaction object including: a virtual figure of the interaction object, and interaction content generated by the interaction object by performing the interactive operation on the multimedia content, where the interaction content is presented within a peripheral preset range of the virtual figure of the interaction object.

Embodiments of the present disclosure further provide an electronic device, including a processor and a memory, the memory having program codes stored therein, and the program codes, when executed by the processor, causing the processor to perform the operations of the method according to any one of the foregoing two methods.

Embodiments of the present disclosure further provide a computer readable storage medium, the computer readable storage medium having a computer instruction stored therein, and the computer instruction, when run on a computer, causing the computer to perform the operations of the method according to any one of the foregoing two methods.

Embodiments of the present disclosure further provide a computer program product, including a computer program, the computer program being stored in a computer-readable storage medium, and when a processor of an electronic device reads the computer program from the computer-readable storage medium, the processor executing the computer program, to cause the electronic device to perform the operations of the method according to any one of the foregoing two methods.

### BRIEF DESCRIPTION OF THE DRAWINGS

FIG. 1 is a schematic diagram of a multimedia content presentation page.

FIG. 2 is an application scenario according to an embodiment of the present disclosure.

FIG. 3 is a flowchart of a page processing method according to an embodiment of the present disclosure.

FIG. 4A is a schematic diagram of a multimedia content presentation page including a plurality of pieces of multimedia content according to an embodiment of the present disclosure.

FIG. 4B is a schematic diagram of a multimedia content presentation page including one piece of multimedia content according to an embodiment of the present disclosure.

FIG. 5A is a schematic diagram of refreshing a multimedia content presentation page according to an embodiment of the present disclosure.

FIG. 5B is a schematic diagram of refreshing a multimedia content presentation page according to an embodiment of the present disclosure.

FIG. 6 is a flowchart of rendering a multimedia content presentation page according to an embodiment of the present disclosure.

FIG. 7 is a schematic diagram of page content information according to an embodiment of the present disclosure.

FIG. 8 is a schematic diagram of an interactive operation information group according to an embodiment of the present disclosure.

FIG. 9 is a schematic diagram of interaction information according to an embodiment of the present disclosure.

FIG. 10 is a schematic diagram of account presentation information according to an embodiment of the present disclosure.

FIG. 11A is a schematic diagram of a multimedia content presentation page according to an embodiment of the present disclosure.

FIG. 11B is a schematic diagram of a multimedia content presentation page according to an embodiment of the present disclosure.

FIG. 11C is a schematic diagram of a multimedia content presentation page according to an embodiment of the present disclosure.

FIG. 12 is a schematic diagram of a second page according to an embodiment of the present disclosure.

FIG. 13A is a schematic diagram of folding presentation of interaction information according to an embodiment of the present disclosure.

FIG. 13B is a schematic diagram of triggering a commenting operation for interaction content according to an embodiment of the present disclosure.

FIG. 14A is a schematic diagram of interaction information according to an embodiment of the present disclosure.

FIG. 14B is a schematic diagram of interaction information according to an embodiment of the present disclosure.

FIG. 15 is a schematic diagram of a multimedia content presentation page according to an embodiment of the present disclosure.

FIG. 16 is a schematic diagram of arrangement presentation of interaction information according to an embodiment of the present disclosure.

FIG. 17 is a schematic diagram of viewing interaction information according to an embodiment of the present disclosure.

FIG. 18A is a schematic diagram of interaction information in an unviewed status according to an embodiment of the present disclosure.

FIG. 18B is a schematic diagram of interaction information in an unviewed status according to an embodiment of the present disclosure.

FIG. 18C is a schematic diagram of interaction information in an unviewed status according to an embodiment of the present disclosure.

FIG. 19 is a schematic diagram of association information according to an embodiment of the present disclosure.

FIG. 20 is a flowchart of determining interaction information that is in an unviewed status according to an embodiment of the present disclosure.

FIG. 21 is a flowchart of rendering an unviewed status to a viewed status according to an embodiment of the present disclosure.

FIG. 22 is a whole flowchart of rendering a multimedia content presentation page according to an embodiment of the present disclosure.

FIG. 23 is a flowchart of determining interaction information that is in an unviewed status according to an embodiment of the present disclosure.

FIG. 24 is a flowchart of updating a multimedia content presentation page based on a newly-added interactive operation according to an embodiment of the present disclosure.

FIG. 25 is a schematic structural diagram of a page processing apparatus according to an embodiment of the present disclosure.

FIG. 26 is a schematic structural diagram of an electronic device according to an embodiment of the present disclosure.

FIG. 27 is a schematic structural diagram of a page processing apparatus according to an embodiment of the present disclosure.

FIG. 28 is a schematic structural diagram of an electronic device according to an embodiment of the present disclosure.

### DESCRIPTION OF EMBODIMENTS

To make the objectives, technical solutions, and advantages of embodiments of the present disclosure clearer, the following clearly and thoroughly describes the technical solutions of the present disclosure with reference to the accompanying drawings in embodiments of the present disclosure. Apparently, the described embodiments are partial embodiments of the technical solutions of the present disclosure rather than all embodiments. All other embodiments obtained by a person of ordinary skill in the art based on embodiments described in files of the present disclosure without creative efforts fall within the protection scope of technical solutions of the present disclosure.

To facilitate a person in the art to understand the technical solutions of the present disclosure better, the following describes some terms involved in the present disclosure.

Universally unique identifier (UUID): An objective is to enable all elements in a distributed system to have unique identification information without specifying the identification information by using a central control end.

MD5: A hash value of a picture is calculated by using a message digest algorithm 5 (MD5) hash algorithm; the obtained MD5 is unique, and whether the picture is changed is determined based on the MD5.

Terms “exemplary”, “For example”, and “for example” used in the following means “used as an example, an embodiment, or a description”. Any embodiment described as “exemplary”, “For example”, and “for example” is not necessarily construed as being superior to or better than another embodiment.

Terms “first” and “second” herein are merely used for description, and cannot be construed as indicating or implying relative importance or implicitly indicating a quantity of indicated technical features. Therefore, a feature defined to be “first” or “second” may explicitly or implicitly include one or more features. In the description of embodiments of the present disclosure, unless otherwise stated, “a plurality of” refers to two or more.

The following is a brief introduction to the design idea of embodiments of the present disclosure:

In some methods, for multimedia content, comments published by different objects are generally presented in a preset arrangement manner. The foregoing arrangement manner may be flexibly configured based on a use requirement. For example, the comments published by different objects may be arranged based on a sequence of publication time. For another example, the comments published by different objects may be arranged based on popularity of the published comments.

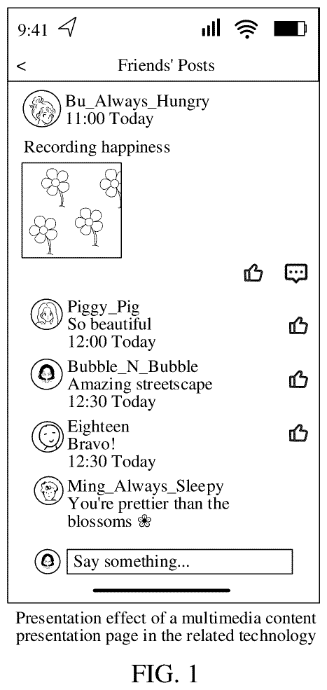

However, regardless of a preset arrangement manner used to present each comment, the comments published by different objects are presented by arrangement. FIG. 1 is a schematic diagram of a multimedia content presentation page according to some methods. This single presentation manner causes comments published by different objects to lack recognition, and causes a comment effect presented on the page to be quite monotonous. In this case, when a large quantity of comments are published, many lines of comments are presented, and when a target object views the comments, it is easy to overlook the comments. Consequently, when the target object searches for a required comment, a large amount of time is taken to perform searching and comparing, which is low in efficiency, and use experience of the target object is degraded. In addition, the comments published by different objects are arranged together, so that the comments published by different objects lack uniqueness of the objects, thereby reducing variety of a comment presentation effect, and reducing use experience of the objects.

Therefore, in some methods, the manner of presenting comments on the page is single, so that the comment presentation effect is quite monotonous, and the use experience of the objects and the target object is reduced.

In view of this, embodiments of the present disclosure provide a page processing method and apparatus, and an electronic device. In the present disclosure, multimedia content and interaction information of at least one interaction object performing an interactive operation on the multimedia content are rendered on a multimedia content presentation page. The interaction information of each interaction object includes: a virtual figure of the interaction object, and interaction content generated by the interaction object by performing the interactive operation on the multimedia content, where the interaction content of the interaction object is presented (or displayed or rendered) within a peripheral preset range of the virtual figure of the interaction object.

Therefore, in solutions provided in embodiments of the present disclosure, after the interaction object performs the interactive operation on the multimedia content, a virtual figure corresponding to a corresponding interaction object and interaction content generated by the corresponding interaction object by performing the interactive operation on the multimedia content can be presented on the multimedia content presentation page.

Based on the foregoing presentation manner provided in the present disclosure, recognition between presented interaction results on the multimedia content presentation page after different interaction objects perform interactive operations can be enhanced, and a difference between the interaction results of different interaction objects is increased, thereby improving recognition between the interaction results on the multimedia content presentation page. Therefore, when searching for an interaction result from many interaction results, a target object can quickly find a required interaction result, reducing searching time of the target object, and improving efficiency of interaction result searching by the target object, thereby improving use experience. In addition, after an interaction object performs an interactive operation, a virtual figure corresponding to the interaction object is on the multimedia content presentation page, to enhance a presentation effect that is presented on the multimedia content presentation page after different interaction objects perform interactive operations, and enrich presentation content on the multimedia content presentation page, thereby improving use experience.

Based on this, embodiments of the present disclosure expand an application scenario of a virtual figure, so that the virtual figure can be associated with an interactive operation performed by an interaction object. After the interaction object performs the interactive operation, the virtual figure of the interaction object can be presented. In addition, by presenting the virtual figure of the interaction object, recognition after different interaction objects perform interactive operations can be increased on the multimedia content presentation page, thereby enhancing recognition between interaction results of different interaction objects on the multimedia content presentation page, and improving efficiency of comment searching by a target object.

Embodiments of the present disclosure are illustrated below in conjunction with the accompanying drawings in the specification. Embodiments described herein are only used to illustrate and explain the present disclosure, and are not used to limit the present disclosure. In addition, embodiments of the present disclosure and features in embodiments may be combined with each other if there is no conflict.

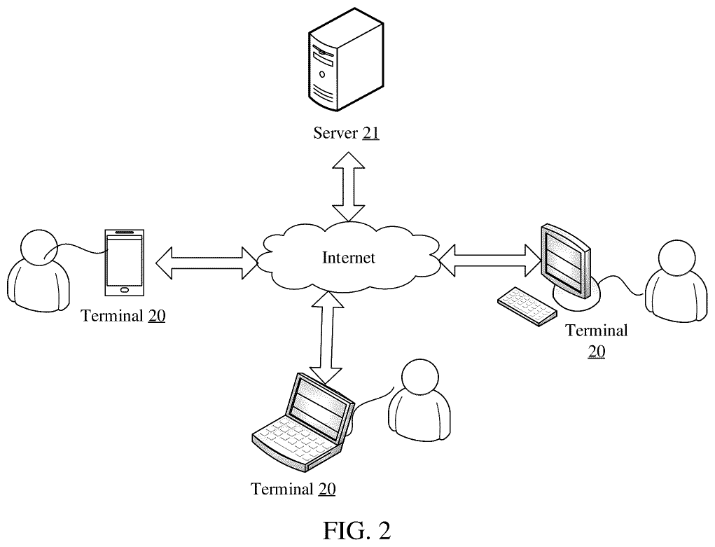

As shown in FIG. 2, FIG. 2 is a schematic diagram of an application scenario according to an embodiment of the present disclosure. The application scenario includes a terminal device 20 and a server 21. The terminal device 20 may communicate with the server 21 through a communication network.

In some implementations, the communication network may be a wired network or a wireless network. Therefore, the terminal device 20 and the server 21 may be directly or indirectly connected in a wired or wireless communication manner. This is not specifically limited in embodiments of the present disclosure.

In embodiments of the present disclosure, the terminal device 20 is an electronic device used by an object. The electronic device may be a computer device that has a computing capability and runs instant messaging software and websites or social software and websites, for example, a personal computer, a mobile phone, a tablet computer, a notebook computer, an e-book reading device, an intelligent voice interaction device, an intelligent household, an on board terminal, and the like. The server 21 may be an independent physical server, or may be a server cluster or a distributed system formed by a plurality of physical servers, or may be a cloud server that provides basic cloud computing services such as a cloud service, a cloud database, cloud computing, cloud storage, a cloud function, a network service, cloud communication, a middleware service, a domain name service, a security service, a content delivery network (CDN), big data, and an artificial intelligence platform.

The page processing method in embodiments of the present disclosure may be performed by an electronic device, and the electronic device may be the terminal device 20 or the server 21. In other words, the method may be performed by the terminal device 20 or the server 21 alone, or may be performed by the terminal device 20 and the server 21 together.

For example, a client is installed on the terminal device 20. An object may trigger an operation on multimedia content by using the client, and send a content obtaining request to the server 21. The server 21 determines page content information corresponding to a multimedia content presentation page, and replies with the page content information to the client on the terminal device 20. The client displays the multimedia content presentation page based on the page content information.

FIG. 2 is merely an example, and actual quantities of terminal devices and servers are not limited, and are not specifically limited in embodiments of the present disclosure.

The following describes a page processing method provided in exemplary implementations of the present disclosure with reference to the foregoing described application scenarios and with reference to the accompanying drawings. The foregoing application scenarios are only for facilitating the understanding of the spirit and principle of the present disclosure, and are not intended to limit the implementations of the present disclosure.

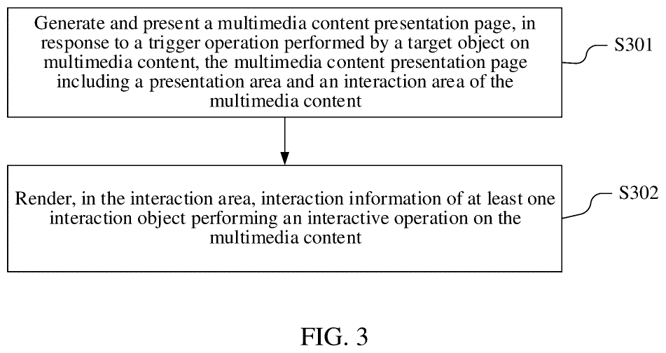

FIG. 3 is a flowchart of a page processing method according to an embodiment of the present disclosure. Using an example in which a client running on a terminal device is an execution body, a specific implementation process of the method is as follows:

Operation S301: Generate and present a multimedia content presentation page in response to a trigger operation performed by a target object on multimedia content, the multimedia content presentation page including a presentation area and an interaction area of the multimedia content.

In embodiments of the present disclosure, the trigger operation performed by the target object on the multimedia content may be a viewing operation for viewing the multimedia content presentation page, or may be a refresh operation for refreshing the multimedia content presentation page. This is not limited in the present disclosure.

The multimedia content presenting page in embodiments of the present disclosure may include one piece of multimedia content, or may include a plurality of pieces of multimedia content.

In embodiments of the present disclosure, the presentation area of the multimedia content is configured to present the multimedia content. The interaction area of the multimedia content is configured to present interaction information of at least one interaction object performing an interactive operation on the multimedia content. The interaction area of the multimedia content may be located at any position within a peripheral range of the presentation area of the multimedia content. For example, the interaction area may be an area below the presentation area. This is not limited in the present disclosure. In addition, the multimedia content presentation page may further include a comment area of the multimedia content.

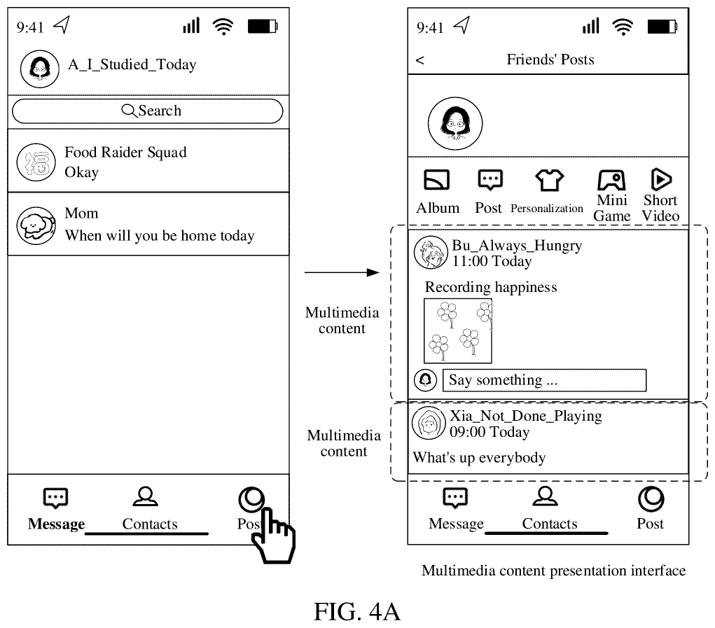

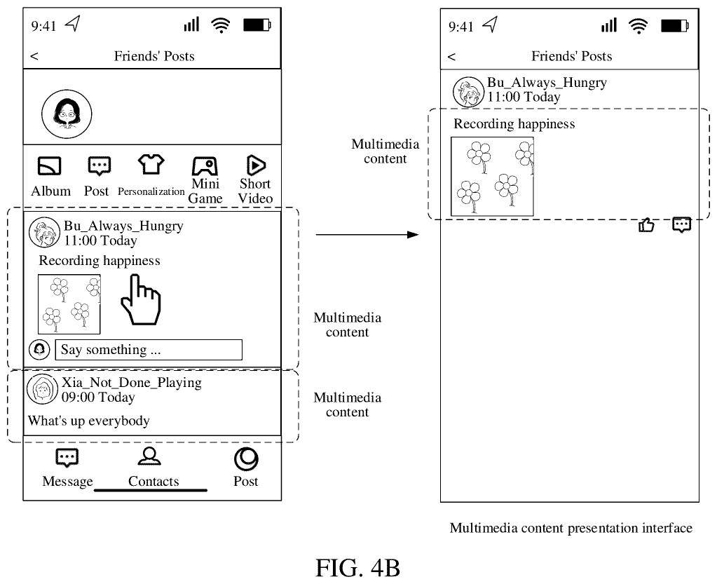

FIG. 4A is a schematic diagram of a multimedia content presentation page including a plurality of pieces of multimedia content according to an embodiment of the present disclosure. A target object triggers a control for viewing a multimedia content presentation page shown in the left figure in FIG. 4A, to present a multimedia content presentation page shown in the right figure in FIG. 4A. The multimedia content presentation page includes a plurality of pieces of multimedia content.

FIG. 4B is a schematic diagram of a multimedia content presentation page including one piece of multimedia content according to an embodiment of the present disclosure. The target object triggers an operation for any multimedia content shown in the left figure in FIG. 4B, and the multimedia content is presented on a multimedia content presentation page shown in the right figure in FIG. 4B.

In embodiments of the present disclosure, a refresh operation is triggered for the multimedia content presentation page in the foregoing example.

During implementation, in the present disclosure, a scroll-down operation may be triggered on the multimedia content presentation page, to trigger the refresh operation; or a refresh control may be triggered, to trigger the refresh operation. This is not limited in the present disclosure.

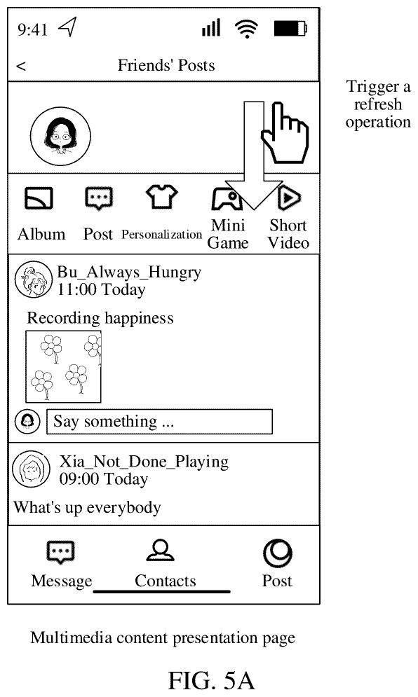

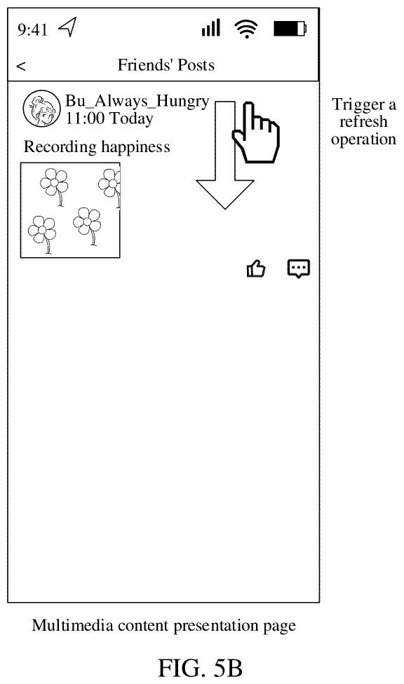

FIG. 5 is a schematic diagram of refreshing a multimedia content presentation page according to an embodiment of the present disclosure. Using triggering a scroll-down operation on the multimedia content presentation page as an example, FIG. 5A is triggering a refresh operation on the multimedia content presentation page shown in FIG. 4A, and FIG. 5B is triggering a refresh operation on the multimedia content presentation page shown in FIG. 4B.

Operation S302: Render, in the interaction area of the multimedia content, interaction information of at least one interaction object performing an interactive operation on the multimedia content.

In embodiments of the present disclosure, each piece of interaction information includes: a virtual figure of a corresponding interaction object, and interaction content generated by the corresponding interaction object by performing the interactive operation on the multimedia content, where the interaction content is presented within a peripheral preset range of the virtual figure of the corresponding interaction object.

In embodiments of the present disclosure, the interaction content may include the following types: audio, text, a picture, a video, and the like. This is not limited in the present disclosure.

In some implementations, for operation S301 and operation S302, if no interaction object performs the interactive operation on the multimedia content, operation S301 is first performed, that is, the multimedia content presentation page including the multimedia content is presented. After it is detected that the interaction object performs the interactive operation on the multimedia content, operation S302 is performed, that is, the interaction information of at least one interaction object performing the interactive operation on the multimedia content is presented in the interaction area of the multimedia content.

In some other implementations, if the interaction object already performs the interactive operation on target multimedia content, operation S301 and operation S302 may be simultaneously performed. In other words, the multimedia content and the interaction information of at least one interaction object performing the interactive operation on the multimedia content are simultaneously presented on the multimedia content presentation page. After it is newly detected that an interactive operation is performed on the multimedia content, operation S302 is performed, that is, interaction information of an interaction object corresponding to the newly-detected interactive operation is presented on the multimedia content presentation page.

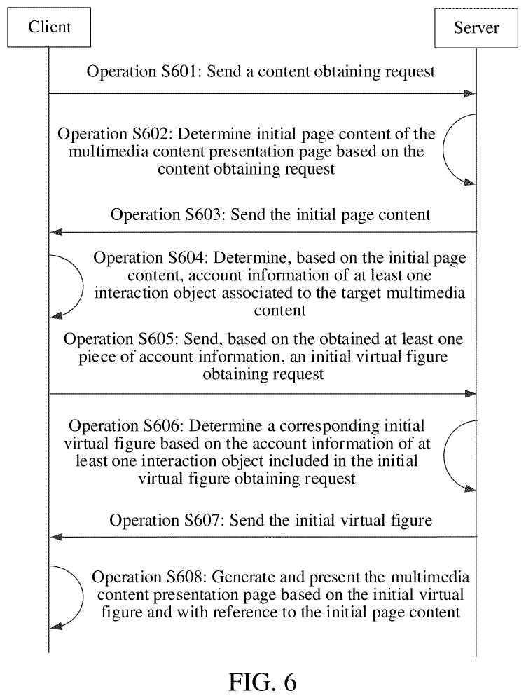

As shown in FIG. 6, using an example in which an interaction object already performs an interactive operation on target multimedia content, FIG. 6 is a whole flowchart of rendering a multimedia content presentation page according to an embodiment of the present disclosure. Specific operations are as follows:

Operation S601: A client sends a content obtaining request to a server.

In embodiments of the present disclosure, the content obtaining request is sent when the client detects a trigger operation performed by a target object on target multimedia content. The content obtaining request includes identification information corresponding to the target multimedia content.

Operation S602: The server determines initial page content of the multimedia content presentation page based on the content obtaining request.

In this embodiment of the present disclosure, the initial page content includes interactive operation information corresponding to at least one interaction object performing an interactive operation on the target multimedia content.

During implementation, the server may determine, based on the identification information corresponding to the target multimedia content and a stored mapping relationship, the interactive operation information of at least one interaction object performing the interactive operation on the target multimedia content.

The mapping relationship in this embodiment of the present disclosure may be a mapping relationship between the identification information corresponding to the target multimedia content and identification information corresponding to interactive operation information of each interaction object performing an interactive operation on the target multimedia content.

The interactive operation information corresponding to the interaction object may include: a type of the interactive operation, account information of the interaction object, comment content, and interaction time.

Operation S603: The server sends the initial page content to the client.

Operation S604: The client determines, based on the initial page content, account information of at least one interaction object performing the interactive operation on the target multimedia content.

During implementation, the initial page content includes the interactive operation information corresponding to at least one interaction object performing the interactive operation on the target multimedia content. In this way, the client may determine, based on the initial page content, the account information of at least one interaction object performing the interactive operation on the target multimedia content.

In this embodiment of the present disclosure, the account information of the interaction object may be an account number of the interaction object.

Operation S605: The client sends, based on the obtained at least one piece of account information, an initial virtual figure obtaining request to the server. In some implementations, S605 may include the client sends, based on the obtained at least one piece of account information, a request for obtaining an initial virtual figure to the server.

Operation S606: The server determines a corresponding initial virtual figure based on the account information of at least one interaction object included in the initial virtual figure obtaining request. In some implementations, S606 may include the server determines a corresponding initial virtual figure based on the account information of at least one interaction object included in the request for obtaining the initial virtual figure.

In this embodiment of the present disclosure, the initial virtual figure may include a virtual figure link corresponding to the at least one interaction object performing the interactive operation on the target multimedia content.

In this embodiment of the present disclosure, if the interaction object sets a corresponding virtual figure, the server may determine the corresponding virtual figure based on the account information. If the interaction object does not set a virtual figure, the server uses a default virtual figure as a virtual figure corresponding to the interaction object.

Operation S607: The server sends the initial virtual figure to the client.

Operation S608: The client generates and presents, based on the initial virtual figure replied by the server and with reference to the initial page content, a multimedia content presentation page.

In some implementations, the client downloads the virtual figure based on the virtual figure link, and presents the downloaded virtual figure in the interaction area of the target multimedia content.

In some embodiments, after downloading the virtual figure, the client may store the successfully downloaded virtual figure into a directory of the client, and name virtual figure resources by using MD5, to subsequently quickly determine whether the virtual figure resources are locally cached.

In some other implementations, the client performs presentation in the interaction area of the target multimedia content based on the stored virtual figure.

After the client successfully downloads the virtual figure, whether the virtual figure has been downloaded or whether the virtual figure changes may be locally determined based on the corresponding MD5. If the virtual figure has been downloaded and is not changed, the virtual figure cached by the client may be directly reused.

In some embodiments, the initial page content may further carry multimedia content basic information corresponding to the target multimedia content.

The target multimedia content in this embodiment of the present disclosure may be multimedia content having an associated interaction object in at least one piece of multimedia content included in the multimedia content presentation page. A quantity of target multimedia content is not limited in the present disclosure. The interaction object associated with the multimedia content is an interaction object performing an interactive operation on the multimedia content.

The multimedia content basic information may include at least one of the following: text information and first multimedia content.

For example, if an object inputs text information when editing the multimedia content, the multimedia content basic information includes the inputted text information. If the object adds first multimedia content when editing the multimedia content, the multimedia content basic information includes the corresponding first multimedia content.

The first multimedia content may be at least one of a picture and a video.

In this embodiment of the present disclosure, the multimedia content basic information may further carry a timestamp for publishing the multimedia content.

The client may determine, based on the initial virtual figure replied by the server and with reference to the initial page content, page content information corresponding to the multimedia content presentation page, and generate and present the multimedia content presentation page based on the page content information.

In this embodiment of the present disclosure, the page content information may further include top comment information.

During implementation, the top comment information may further be determined based on a preset condition and the interactive operation information corresponding to the target multimedia content, and the top comment information is presented in a comment area of the target multimedia content.

For example, interactive operation information having the highest popularity may be determined based on popularity corresponding to each piece of interactive operation information corresponding to the target multimedia content. In this case, the top comment information includes identification information corresponding to the interactive operation information which has the highest popularity and corresponds to the target multimedia content.

In this embodiment of the present disclosure, on the multimedia content presentation page, the top comment information may be presented in the comment area of the target multimedia content.

For example, the comment area of the target multimedia content may be located in an area below the presentation area of the target multimedia content.

In this embodiment of the present disclosure, the popularity of the interactive operation information may be a quantity of thumbs-ups corresponding to the interactive operation information.

The top comment information may be determined by the client, or may be determined by the server. If the top comment information is determined by the server, the initial page content further includes the top comment information.

The page content information includes: the multimedia content basic information corresponding to the target multimedia content, the top comment information associated with the target multimedia content, and the interactive operation information of at least one associated interaction object.

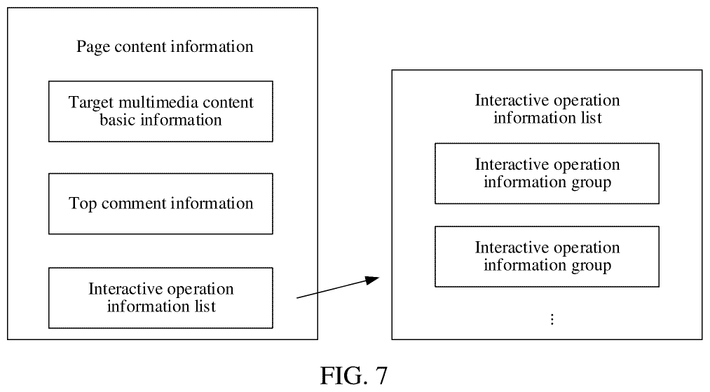

FIG. 7 is a schematic diagram of page content information according to an embodiment of the present disclosure. Using the target multimedia content as an example, the page content information includes the target multimedia content basic information, the top comment information associated with the target multimedia content, and an interactive operation information list of at least one interaction object associated with the target multimedia content.

The interactive operation information list includes at least one interactive operation information group, and each interactive operation information group includes interactive operation information of at least one interaction object.

In this embodiment of the present disclosure, the interactive operation may include a thumbs-up operation and a commenting operation, the interactive operation information list may be a thumbs-up/comment list corresponding to the target multimedia content, and the interactive operation information group may be a thumbs-up/comment group.

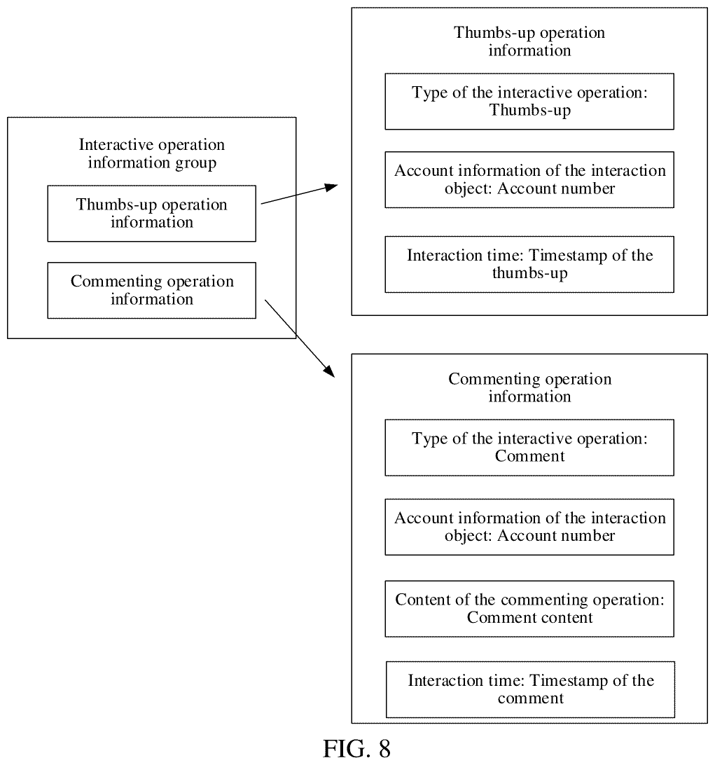

FIG. 8 is a schematic diagram of an interactive operation information group according to an embodiment of the present disclosure. If the interactive operation information group includes thumbs-up operation information and commenting operation information, composition content corresponding to the thumbs-up operation information includes: a type of the interactive operation: thumbs-up; account information of an interaction object: an account number; no comment content; and interaction time: a timestamp of the thumbs-up. In addition, composition content corresponding to the commenting operation information includes: a type of the interactive operation: comment; account information of an interaction object: an account number; comment operation content: comment content; and interaction time: a timestamp of the comment.

The type of the interactive operation may be represented by using type, the content of the commenting operation may be represented by content, and the interaction time is time when the interaction object triggers the interaction operation, and may be represented by timestamp. These are not limited in the present disclosure.

The thumbs-up operation information in FIG. 8 corresponds to the commenting operation information.

During implementation, based on the multimedia content basic information of the target multimedia content included in the initial page content, the text information or the first multimedia content in the target multimedia content may be presented on the multimedia content presentation page.

The first multimedia content may be at least one of a picture and a video. The initial page content may further include multimedia content basic information of another multimedia content in addition to the target multimedia content. In this case, when the text information or the first multimedia content in the target multimedia content is presented on the multimedia content presentation page, text information or first multimedia content of the another multimedia content is simultaneously presented on the multimedia content presentation page.

In this embodiment of the present disclosure, based on account information corresponding to each virtual figure and based on account information in the interactive operation information corresponding to at least one interaction object in the initial page content, the virtual figure and the corresponding interactive operation information may be presented in a combined manner.

Interactive operations in embodiments of the present disclosure include at least one of the following:

Interactive operation 1: a commenting operation performed by a corresponding interaction object on the target multimedia content;

Interactive operation 2: a thumbs-up operation performed by a corresponding interaction object on the target multimedia content.

In this embodiment of the present disclosure, based on the foregoing interactive operation, interaction information of at least one interaction object performing the interactive operation on the multimedia content is rendered in the interaction area of the target multimedia content.

In this embodiment of the present disclosure, the interaction area of the target multimedia content may be at any position within a peripheral preset range of the presentation area of the target multimedia content. This is not limited in the present disclosure.

For example, the interaction area of the target multimedia content may be located in an area below the comment area of the target multimedia content.

The interaction information of each interaction object includes: a virtual figure of a corresponding interaction object, and interaction content generated by the corresponding interaction object by performing the interactive operation on the target multimedia content, where the interaction content is presented within a peripheral range of the virtual figure of the corresponding interaction object.

For example, in this embodiment of the present disclosure, when the interaction content is presented within the peripheral range of the virtual figure, the interaction content may be presented at any position within the peripheral range of the virtual figure.

For example, in this embodiment of the present disclosure, the interaction content is presented at an overhead position within the peripheral range of the virtual figure, or the interaction content is presented at an underfoot position within the peripheral range of the virtual figure, or the interaction content is presented at a left-hand position within the peripheral range of the virtual figure, or the interaction content is presented at a right-hand position within the peripheral range of the virtual figure. This is not limited in the present disclosure.

The present disclosure does not limit the interactive operation to be merely the commenting operation and the thumbs-up operation, and the interactive operation may alternatively be a sharing operation or the like. This is not limited in the present disclosure.

In this embodiment of the present disclosure, different interaction content is displayed for different interactive operations.

For example, if the interaction object performs the commenting operation on target multimedia data, interaction content corresponding to the commenting operation is presented. If the interaction object performs the thumbs-up operation on the target multimedia data, interaction content corresponding to the thumbs-up operation is presented.

In this embodiment of the present disclosure, the interaction content corresponding to the commenting operation may be comment content of the interaction object, and the interaction content corresponding to the thumbs-up operation may be a thumbs-up icon.

The thumbs-up icon in this embodiment of the present disclosure is used to indicate that the interaction object performs the thumbs-up operation.

Types of the interaction content are not limited in the present disclosure. The interaction content may include the following types: text, a picture, audio, a video, and the like.

Based on the foregoing interactive operation, in this embodiment of the present disclosure, the interaction content may be presented within a peripheral range of a virtual figure of a corresponding interaction object.

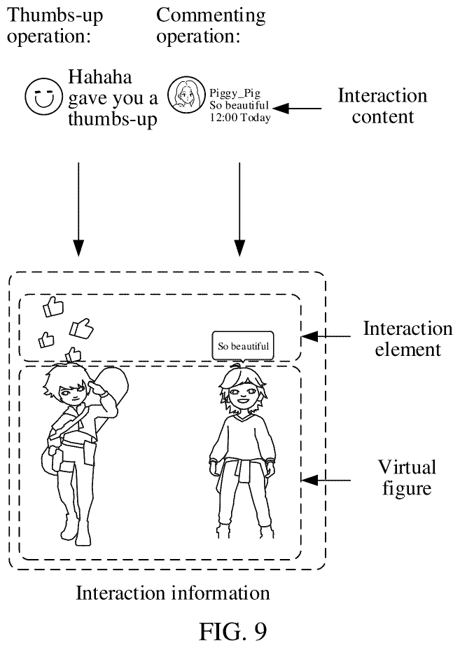

As shown in FIG. 9, if comment content in a commenting operation performed by an interaction object “Piggy_Pig” on target multimedia content is “So beautiful”, interaction information corresponding to “Piggy_Pig” is presented, including: a virtual figure of “Piggy_Pig”, and the comment content “So beautiful” presented within a peripheral range of the virtual figure. If an interaction object “Hahaha” performs a thumbs-up operation on the target multimedia content, interaction information corresponding to “Hahaha” is presented, including: a virtual figure of “Hahaha”, and a thumbs-up icon presented within a peripheral range of the virtual figure.

The comment content “So beautiful” of the interaction object “Piggy_Pig” is interaction content corresponding to the interaction object “Piggy_Pig”.

In some embodiments, interaction information of an interaction object may further include account presentation information corresponding to the corresponding interaction object.

For example, this embodiment of the present disclosure provides the following several account presentation manners, to display account presentation information corresponding to an interaction object:

Account presentation manner 1: presenting, within a peripheral range of a virtual figure of the interaction object, account presentation information corresponding to the interaction object;

Account presentation manner 2: presenting, in interaction content of the interaction object, account presentation information corresponding to the interaction object.

In this embodiment of the present disclosure, the account presentation information corresponding to the interaction object may include at least one of the following: an account nickname of the interaction object, or an account profile photo of the interaction object.

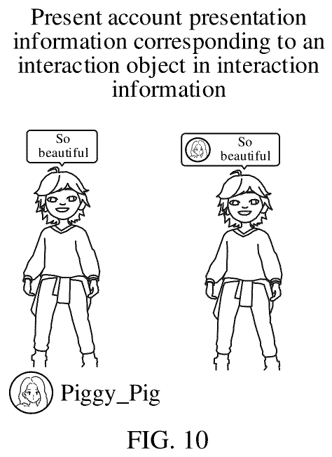

For example, as shown in FIG. 10, using the interactive operation of the interaction object “Piggy_Pig” in FIG. 9 as an example, an account nickname and an account profile photo of “Piggy_Pig” may be presented within a peripheral range of a virtual figure of “Piggy_Pig”, or the account profile photo of “Piggy_Pig” may be presented in the interaction content of “Piggy_Pig”.

A virtual figure may be preset by each interaction object, or may be preset by default.

In this embodiment of the present disclosure, based on the interactive operation performed by each interaction object on the target multimedia content, the interaction information of each interaction object is presented on the multimedia content presentation page, and the interaction content corresponding to each interaction object may also be presented.

For example, the interaction content corresponding to the interaction object includes the comment content “So beautiful” of the interaction object “Piggy_Pig” in FIG. 9.

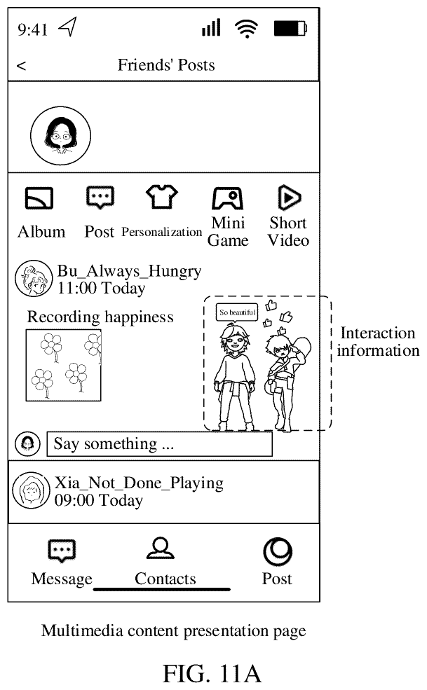

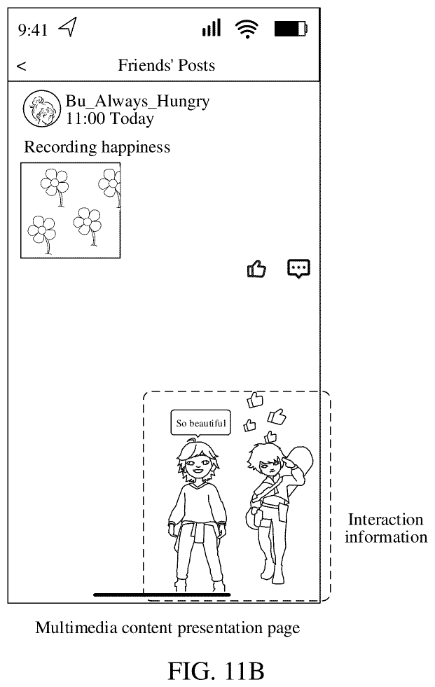

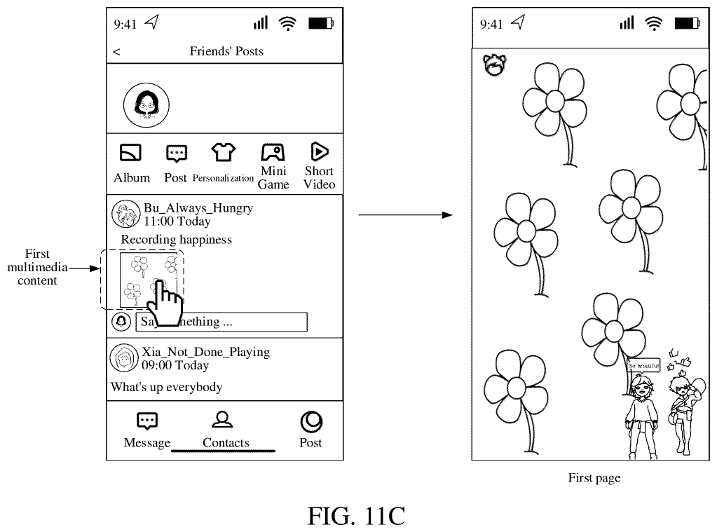

Based on the foregoing process, the multimedia content presentation page including the interaction information of at least one interaction object performing the interactive operation on the target multimedia content may be shown in FIG. 11. Based on the right figure in FIG. 4A, this embodiment of the present disclosure provides a multimedia content presentation interface as shown in FIG. 11A. Based on the right figure in FIG. 4B, this embodiment of the present disclosure provides a multimedia content presentation interface as shown in FIG. 11B.

In this embodiment of the present disclosure, on the multimedia content presentation page, the interaction information of at least one interaction object performing the interactive operation on the target multimedia content may be presented in the interaction area of the target multimedia content.

For example, the interaction area of the target multimedia content is an arca below the presentation area of the target multimedia content. The interaction information of at least one interaction object performing the interaction operation on the target multimedia content may be presented in the area below the presentation area of the target multimedia content on the multimedia content presentation page.

In some embodiments, based on first multimedia content on the multimedia content presentation page shown on the right side of FIG. 11A or on the right side of FIG. 11B, in response to a trigger operation performed by the target object on the first multimedia content, the first multimedia content may be presented on a first page, and the interaction information of each interaction object performing the interactive operation on the first multimedia content may be presented.

If a presentation area of the image (namely, the first multimedia content) on the first page exceeds a preset range, the interaction information of the interaction object may be presented in an overlapping manner with a partial presentation area of the image. For example, as shown in the right figure in FIG. 11C, the interaction information is overlapped on the lower right side of the presentation area of the image for presentation.

In this embodiment of the present disclosure, before the interaction information of each interaction object performing the interactive operation on the target multimedia content is presented as shown in the right figure of FIG. 11C, a control for viewing the interaction information (for example, a control displayed at the upper left corner of a picture in a page shown in the right figure of FIG. 11C) may be triggered to present, in response to an operation of viewing the interaction information triggered by the target object, the interaction information of each interaction object performing the interactive operation on the target multimedia content.

When a picture is presented before the target object triggers the operation of viewing the interaction information, a displayed control for viewing the interaction information is in a status of not presenting the interaction information. After the target object triggers the control for viewing the interaction information, the displayed control for viewing the interaction information is in a status of presenting the interaction information (for example, a status of the control shown at the upper left corner of the picture in FIG. 11C), and the interaction information is presented on the picture.

When the control for viewing the interaction information is in the status of not presenting the interaction information, interaction content of the interaction object and a profile photo of the interaction object may be presented on the picture. The presented interaction content of the interaction object and the profile photo of the interaction object may both be displayed on the picture in a floating status.

In some embodiments, content presented on the picture may be switched by the target object by changing a status of the control for viewing the interaction information.

For example, when the control for viewing the interaction information is in a status of not presenting the interaction information, if the control for viewing the interaction information is triggered, the interaction content of the interaction object and the profile photo of the interaction object that are presented on the picture are switched to the interaction information of the interaction object for presentation.

In some embodiments, in addition to the foregoing interactive operation 1 and the interactive operation 2, the interactive operation in this embodiment of the present disclosure may be at least one of the following:

Interactive operation 3: a commenting operation performed by a corresponding interaction object for an interaction result on the target multimedia content;

Interactive operation 4: a thumbs-up operation performed by a corresponding interaction object for an interaction result on the target multimedia content.

In this embodiment of the present disclosure, the interaction result is obtained after the interaction object performs the interactive operation on the target multimedia content.

For example, the interaction result may be at least one kind of interaction information or interactive operation information presented on the multimedia content presentation page after the interaction object performs the interactive operation on the target multimedia content.

In this embodiment of the present disclosure, the interactive operation is triggered on the interaction result in the following several triggering manners, which are specifically as follows:

Triggering manner 1: performing the interactive operation on the interaction information on the multimedia content presentation page.

In some implementations, in this embodiment of the present disclosure, after the interactive operation is triggered for the target interaction information in the interaction information of at least one interaction object, a type of the interactive operation may be determined according to different preset triggering rules.

For example, in this embodiment of the present disclosure, a long-press operation may be triggered on the target interaction information to trigger a thumbs-up operation on the target interaction information; and a commenting operation may be triggered on the target interaction information by triggering a scroll-up operation on the target interaction information, to present an area in which comment content is to be inputted for the interaction object to input the comment content.

The target interaction information is interaction information selected for the interactive operation to be triggered on.

In some other implementations, in this embodiment of the present disclosure, a viewing operation may be triggered for the target interaction information in the interaction information of at least one interaction object, and a second page is rendered in response to the viewing operation triggered for the target interaction information. The second page includes: the target interaction information, the area in which the comment content is to be inputted, and a control, presented in a preset area of the second page, that triggers the interactive operation on the target interaction information.

The control that triggers the interactive operation on the target interaction information may include a control that triggers the thumbs-up operation.

Based on any one of FIG. 11A, FIG. 11B, and FIG. 11C, in this embodiment of the present disclosure, the viewing operation may be triggered for the target interaction information, and the second page is presented. On the second page, the target object may trigger the interactive operation for the target interaction information.

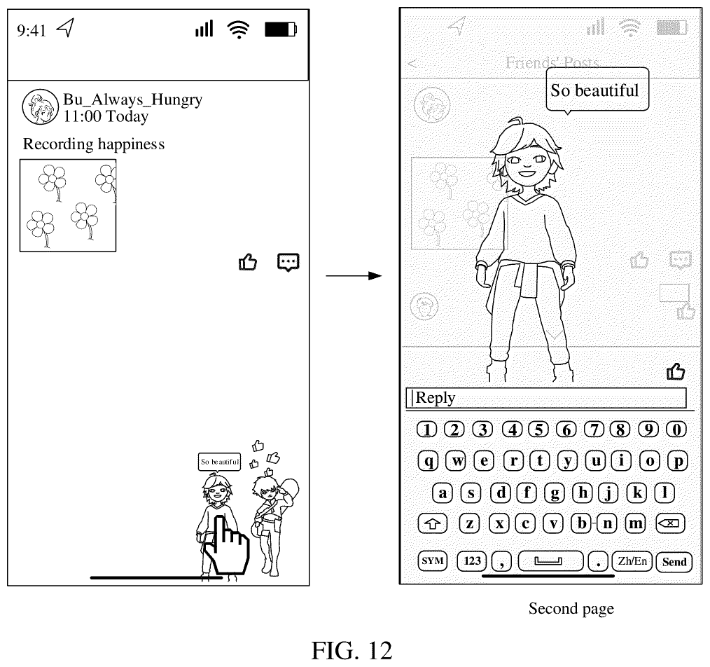

FIG. 12 is a schematic diagram of a second page according to an embodiment of the present disclosure based on an example shown in FIG. 11B. In the left figure in FIG. 12, the target object triggers the viewing operation by using the target interaction information of at least one interaction object. In the right figure in FIG. 12, a second page corresponding to the target interaction information is presented.

Triggering manner 2: triggering the interactive operation for interaction content on the multimedia content presentation page.

In this embodiment of the present disclosure, interaction content corresponding to the target multimedia content may further be presented on the multimedia content presentation page.

The interaction content in this embodiment of the present disclosure is the comment content and the thumbs-up information of the interaction object shown in FIG. 9.

In some embodiments, before the interaction content corresponding to the target multimedia content is presented, a presentation operation on the interaction content may be triggered on the multimedia content presentation page. In response to an unfolding operation triggered by the target object on the interaction content, the interaction content corresponding to the target multimedia content is unfolded and presented on the multimedia content presentation page.

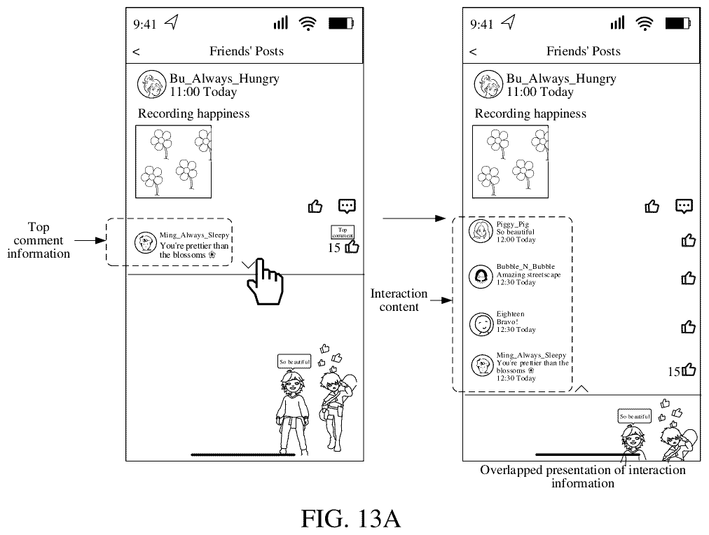

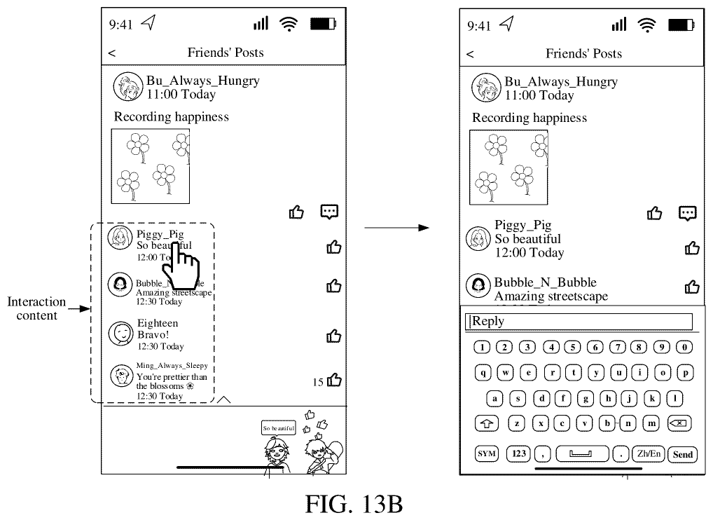

Using a figure as an example, as shown in the left figure in FIG. 13A, the target object triggers the unfolding operation triggered for the interaction content, to present, on the multimedia content presentation page shown in the right figure in FIG. 13A, unfolded interaction content corresponding each interaction object. In some embodiments, after the interaction content is unfolded and presented, in this embodiment of the present disclosure, the interaction information of at least one interaction object performing the interactive operation on the target multimedia content may be folded and presented, to present a partial area of the interaction information.

In this embodiment of the present disclosure, the interaction content may be presented based on the interactive operation information list in the page content information.

In some embodiments, as shown in the left figure in FIG. 13A, in this embodiment of the present disclosure, top comment information corresponding to the target multimedia content may further be presented. The top comment information is interaction content that meets a preset condition.

For example, as shown in the left figure in FIG. 13A, for the target multimedia content, the interaction content that meets the preset condition and is presented on the multimedia content presentation page may be “You're prettier than the blossoms [symbol] ”, and popularity corresponding to the interaction content, such as a quantity of thumbs-ups shown in the left figure in FIG. 13A, may also be presented.

A preset icon, such as “Top comment” shown in the left figure in FIG. 13A, may further be presented in the interaction content that meets the preset condition.

During implementation, in the interactive operation information corresponding to each interaction object, interactive operation information having the highest popularity is determined in each piece of interactive operation information based on the preset condition, and the top comment information includes: identification information corresponding to the interactive operation information which has the highest popularity and corresponds to the target multimedia content.

In some embodiments, in this embodiment of the present disclosure, the client may alternatively determine the top comment information.

In this embodiment of the present disclosure, corresponding interaction content that needs to be presented may be determined based on the target interactive operation information.

As shown in the left figure in FIG. 13A, thumbs-up operation information corresponding to the quantity of thumbs-ups corresponds to commenting operation information corresponding to “You're prettier than the blossoms [symbol] ”.

In some embodiments, based on the right figure in FIG. 13A, in this embodiment of the present disclosure, the interactive operation may be triggered by interaction content of any interaction object.

For example, a thumbs-up icon corresponding to the target interaction content may be tapped, to trigger a thumbs-up operation. Alternatively, the target interaction content may be tapped, to present an area in which comment content is to be inputted for the interaction object to input the comment content.

As shown in FIG. 13B, an example in which a commenting operation is triggered on target multimedia content is used. The target interaction content is tapped on a multimedia content presentation page shown in the left figure in FIG. 13B, and the area in which the comment content is to be inputted is presented in a partial area of the multimedia content presentation page shown in the right figure in FIG. 13B, for the interaction object to input the comment content.

The foregoing account presentation manner is also applicable to the interactive operation 3 and the interactive operation 4, and details are not described herein again in the present disclosure.

In this embodiment of the present disclosure, based on the foregoing interactive operation 3 and interactive operation 4, the following interaction presentation manners of interaction information are provided, which are specifically as follows:

Interaction presentation manner 1: rendering interaction information of a corresponding interaction object, and presenting marked information in the interaction information.

In this embodiment of the present disclosure, if the interaction object performs the interactive operation on an interaction result, the marked information is presented in the interaction information, to indicate an association between the interaction object and an interaction object corresponding to the interaction result.

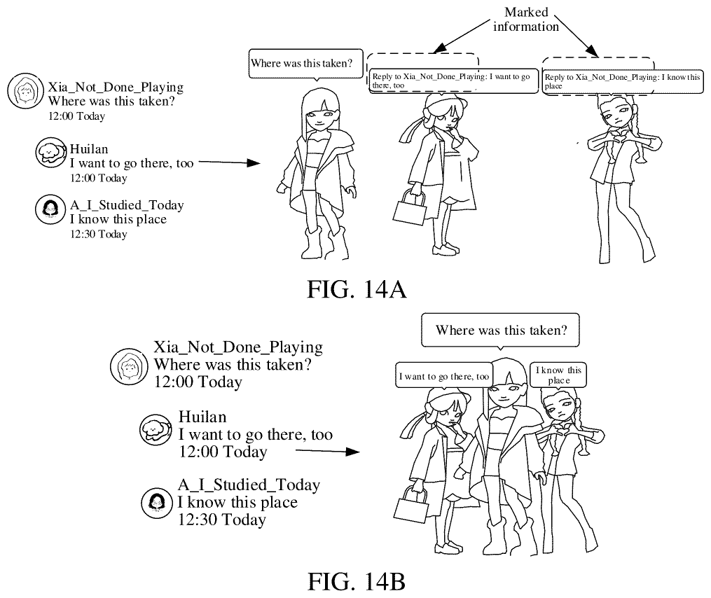

For example, an interaction result “Where was this taken?” sent by an interaction object “Huilan” to an interaction object “Xia_Not_Done_Playing” triggers a commenting operation, and comment content published is “I want to go there, too”. In this case, marked information may be presented in interaction information of the interaction object “Huilan”, as shown in FIG. 14A.

In this embodiment of the present disclosure, interaction information of different interaction objects may be arranged based on an interaction time of the interaction objects.

Interaction presentation manner 2: rendering, in a preset combination manner, interaction information of an interaction object corresponding to an interaction result and interaction information of an indirect interaction object.

In this embodiment of the present disclosure, the indirect interaction object is an interaction object performing an interactive operation on an interaction result of the target multimedia content.

For example, presenting a multimedia content presentation page includes: presenting, on the multimedia content presentation page, in the preset combination manner, the interaction information of the interaction object corresponding to the interaction result of at least one interaction object performing the interactive operation on the target multimedia content (that is, the interaction information of the interaction object performing the interactive operation on the target multimedia content), and the interaction information of the indirect interaction object (that is, the interaction information of the interaction object performing the interactive operation on the interaction result of the target multimedia content).

The presented interaction information of the interaction object corresponding to the interaction result includes: a virtual figure of the corresponding interaction object, and presented interaction content of the corresponding interaction object within a peripheral preset range of the virtual figure of the corresponding interaction object; and
the presented interaction information of the indirect interaction object includes: a virtual figure of the indirect interaction object, and rendered interaction content that is generated within a peripheral preset range of the virtual figure of the indirect interaction object by the indirect interaction object by performing the interaction operation on the interaction result.

For example, an indirect interaction result “Where was this taken?” sent by the interaction object “Huilan” to the interaction object “Xia_Not_Done_Playing” triggers a commenting operation, and comment content published is “I want to go there, too”. In this case, the interaction information of the indirect interaction object “Huilan” and interaction information of the interaction object “Xia_Not_Done_Playing” may be combined and presented in the preset combination manner, as shown in FIG. 14B.

In this embodiment of the present disclosure, interaction information of different interaction objects that is combined in the preset combination manner may be arranged based on interaction time of the interaction objects corresponding to the interaction result.

In some embodiments, if the indirect interaction object triggers a thumbs-up operation on the interaction information of the interaction object corresponding to the interaction result, in addition to the combination manner shown in FIG. 14B, a virtual figure corresponding to the interaction object may be presented on the multimedia content presentation page, and combined interaction content corresponding to the interaction object and interaction content of the indirect interaction object are presented within a peripheral range of the virtual figure corresponding to the interaction object.

For example, within a peripheral range of a virtual figure of the interaction object “Xia_Not_Done_Playing”, comment content “Where was this taken?” corresponding to the commenting operation after combination and a thumbs-up icon corresponding to the thumbs-up operation are rendered.

Based on FIG. 14A, and as shown in FIG. 14B, composition content in an interactive operation group corresponding to the interactive operation 3 and the interactive operation 4 may include: thumbs-up operation information and at least one piece of commenting operation information.

In this embodiment of the present disclosure, the at least one piece of commenting operation information may include commenting operation information corresponding to the interaction object and commenting operation information corresponding to at least one indirect interaction object.

For composition content in the thumbs-up operation information and the commenting operation information, refer to FIG. 8. Details are not described herein again in the present disclosure.

In this embodiment of the present disclosure, the preset combination manner may include at least one of the following combination presentation manners:

Combination presentation manner 1: adopting different presentation settings for the interaction content of the interaction object and the interaction content of the indirect interaction object.

A presentation setting provided in this embodiment of the present disclosure may include at least one of the following: a presentation area of the interaction content or a presentation color of the interaction content.

For example, a presentation area corresponding to the interaction content of the interaction object may be set to be larger than a presentation area corresponding to the interaction content of the indirect interaction object. Alternatively, different presentation colors are respectively set for the interaction content of the interaction object and the interaction content of the indirect interaction object.

Combination presentation manner 2: adopting different presentation settings for the virtual figure of the interaction object and the virtual figure of the indirect interaction object.

In this embodiment of the present disclosure, presentation areas of virtual figures may be set differently.

For example, a presentation area corresponding to the virtual figure of the interaction object may be set to be larger than a presentation area corresponding to the virtual figure of the indirect interaction object.

Therefore, an obtained presentation effect is: the virtual figure of the interaction object is larger than the virtual figure of the indirect interaction object.

Combination presentation manner 3: adopting a preset position to perform combination for the interaction information of the interaction object and the interaction information of the indirect interaction object.

The presentation area of the interaction content and the presentation area of the virtual figure are both included in the interaction area of the target multimedia content.

In some implementations, the interaction information of the interaction object corresponding to the interaction result and the interaction information of at least one indirect interaction object may be arranged from left to right based on a time sequence of interaction.

In some other implementations, based on the time sequence of interaction, the interaction information of at least one indirect interaction object may be arranged on both sides of the interaction information of the interaction object corresponding to the interaction result by using the interaction information of the interaction object corresponding to the interaction result as a center.

Based on the foregoing process, after the interactive operation on the interaction result is triggered by using the interactive operation 3 and the interactive operation 4, the interaction information of the interaction object corresponding to the interaction result and the interaction information of the indirect interaction object presented in the preset combination manner on the multimedia content presentation page can be obtained.

In some embodiments, when the indirect interaction object performs the interactive operation on the interaction result of the target multimedia content, the following several indirect interaction manners are included:

Indirect interaction manner 1: an interactive operation triggered on target interaction information in the interaction information of at least one interaction object on the multimedia content presentation page.

For a process principle, refer to a process principle of the triggering manner 1 in a process of “the interactive operation is triggered on the interaction result” provided in embodiments of the present disclosure.

Indirect interaction manner 2: an interactive operation triggered on target interaction content in the interaction content of at least one interaction object on the multimedia content presentation page.

For a process principle, refer to a process principle of the triggering manner 2 in a process of “the interactive operation is triggered on the interaction result” provided in embodiments of the present disclosure.

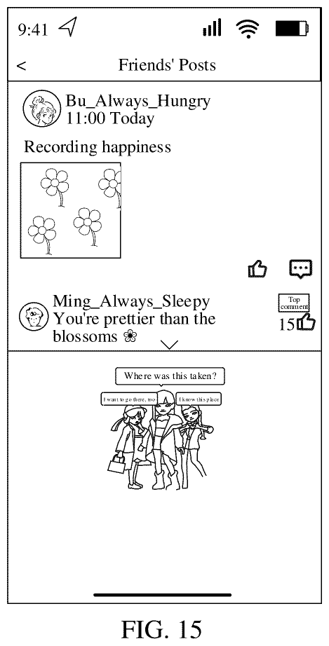

Based on the foregoing process, as presented on the multimedia content presentation page, the interaction information corresponding to the interactive operation 3 and the interactive operation 4 may be processed in the preset combination manner. Using the multimedia content presentation page shown in FIG. 4B as an example, the interaction information combined in the preset combination manner is shown in FIG. 15.

In this embodiment of the present disclosure, a status tag of the interaction information of at least one interaction object is further rendered on the multimedia content presentation page.

In this embodiment of the present disclosure, two types of status tags of the interaction information are included, which are respectively configured to represent an unviewed status of the interaction information and a viewed status of the interaction information.

In this case, on the multimedia content presentation page of the present disclosure, a status tag of the interaction information of at least one interaction object performing the interactive operation on the target multimedia content is the unviewed status or the viewed status.

Preset placement locations of interaction information in the unviewed status and interaction information in the viewed status are different. In this case, when the target object views interaction information in the multimedia content presentation page, the target object can distinguish the interaction information in the unviewed status from the interaction information in the viewed status, so that the target object can rapidly find the interaction information in the unviewed status without repeatedly viewing the interaction information in the viewed status, thereby saving time spent by the target object in searching for the interaction information in the unviewed status, and improving efficiency of viewing the interaction information by the target object.

In this embodiment of the present disclosure, if the interaction information in the viewed status and corresponds to the interaction object performing the interactive operation on the target multimedia content already exists, the interaction information of which the status tag is the viewed status is presented in a preset viewed presentation area in a preset first arrangement manner.

The presented interaction information in the viewed status is arranged based on interaction time when the interaction object corresponding to the interaction information performs the interactive operation.

In some implementations, the preset first arrangement manner is determined based on interaction time when the interaction object corresponding to the interaction information performs the interactive operation.

In some embodiments, the first arrangement manner may perform, based on interaction time corresponding to at least one interaction object, arrangement and presentation in a sequence from later interaction time to earlier interaction time, and may be arranged based on a preset layout.

For example, the preset layout may be any one of the following: arranging based on a straight line, arranging based on a curve, or arranging based on a particular shape. This is not limited in the present disclosure.

In this embodiment of the present disclosure, a sequence of interactive operation information groups in the interactive operation information corresponding to the target multimedia content may be adjusted, to adjust the arrangement and presentation sequence of interaction information of interaction objects performing the interactive operation on the target multimedia content.

In this embodiment of the present disclosure, a client or a server may adjust the sequence of the interactive operation information groups, to adjust the arrangement and presentation sequence of the interaction information of the interaction objects performing the interactive operation on the target multimedia content.

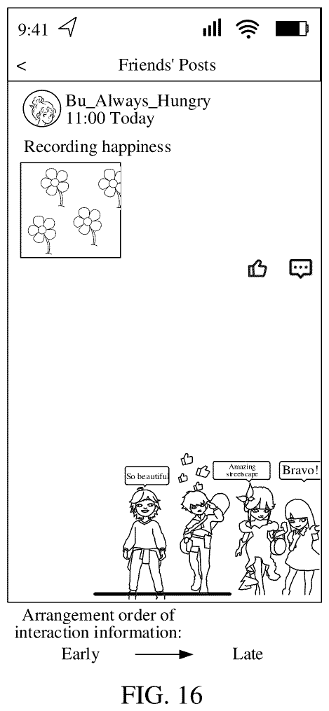

For example, as shown in FIG. 16, after the target object triggers an operation on the target multimedia content, the interaction information of the interaction objects performing the interactive operation on the target multimedia content is presented in a bottom area of FIG. 16. The interaction information of the interaction objects is arranged and presented based on interaction time.

As a display area of a terminal display screen is limited, the interaction information of all the interaction objects cannot be presented. Therefore, based on a size of the interaction area of the target multimedia content on the terminal display screen, interaction information of partial interaction objects is first presented in the interaction area of the target multimedia content, and interaction information of other interaction objects is hidden.

In this embodiment of the present disclosure, the target object may trigger a sliding operation on interaction information of displayed interaction objects in the interaction area of the target multimedia content, and in response to the sliding operation triggered by the target object, interaction information of other interaction objects is presented in the interaction area of the target multimedia content.

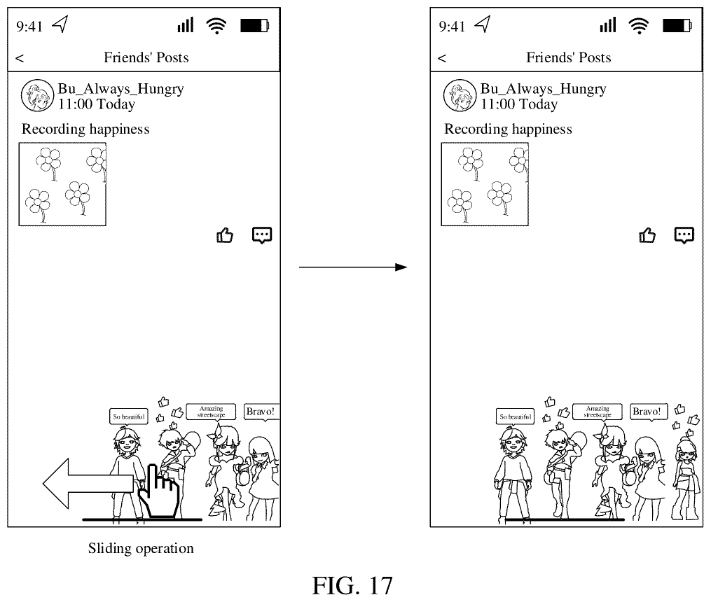

As shown in FIG. 17, in the left figure in FIG. 17, the target object triggers a sliding operation leftwards on interaction information of interaction objects, and as shown in the right figure in FIG. 17, interaction information of other interaction objects is presented to the target object.

If the interaction information of the interaction objects is arranged and presented from left to right based on a sequence of interaction time, presented interaction information of other interaction objects is also arranged based on a sequence of corresponding interaction time.

In this embodiment of the present disclosure, if the interaction information in the unviewed status and corresponds to the interaction object performing the interactive operation on the target multimedia content exists, the interaction information of which the status tag is the unviewed status is presented in a preset unviewed presentation area in a preset second arrangement manner.

The presented interaction information in the unviewed status is arranged based on an interaction time when the interaction object corresponding to the interaction information performs the interactive operation.

In some implementations, the preset second arrangement manner is determined based on interaction time when the interaction object corresponding to the interaction information performs the interactive operation.

In this embodiment of the present disclosure, the second arrangement manner may perform, based on interaction time corresponding to at least one interaction object, arrangement and presentation in a sequence from earlier interaction time to later interaction time, and may be arranged based on a preset layout.

The preset layout may be any one of the following: arranging based on a straight line, arranging based on a curve, or arranging based on a particular shape. This is not limited in the present disclosure.

For example, in this embodiment of the present disclosure, the interaction information in the unviewed status may be arranged based on the straight line. The interaction information of the interaction objects is arranged and presented in a sequence from later interaction time to earlier interaction time. For example, arrangement and presentation may be performed from left to right based on the sequence from the later interaction time to the earlier interaction time.

In this embodiment of the present disclosure, for the interactive operations 1 and 2 and the interactive operations 3 and 4, a same preset area may be set for presentation, or different preset areas may be respectively set for presentation.

If different preset areas are respectively set for presentation, in this embodiment of the present disclosure, the interactive operations 1 and 2 and the interactive operations 3 and 4 may be sorted in a same time sequence, or the interactive operations 1 and 2 and the interactive operations 3 and 4 may be sorted in respective time sequences.

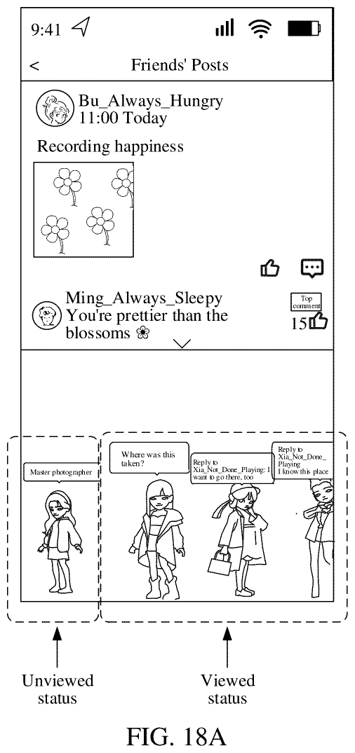

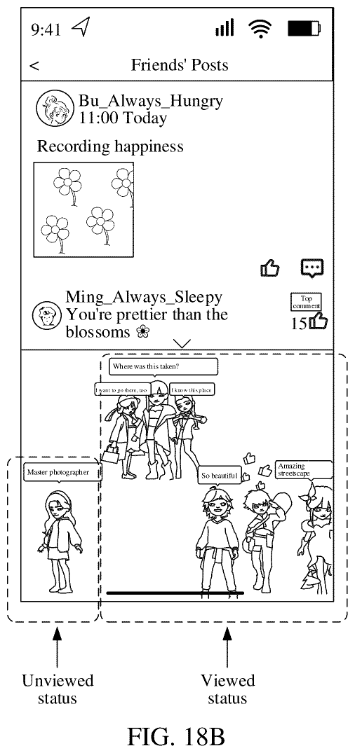

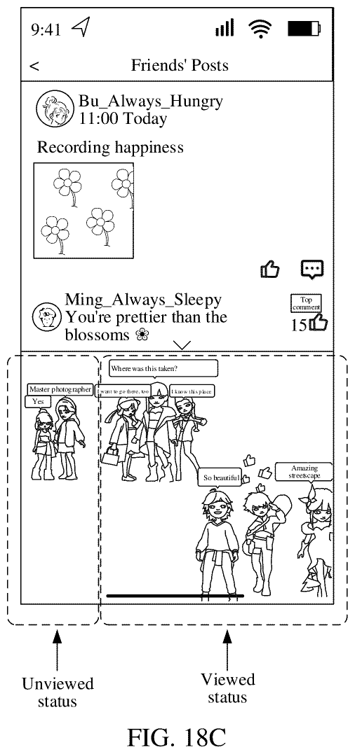

In this embodiment of the present disclosure, the same preset area is set for the interactive operations 1 and 2 and the interactive operations 3 and 4 for presentation, and a presentation effect as shown in FIG. 18A is provided based on a situation of sorting in the same time sequence.

In this embodiment of the present disclosure, for the interactive operations 1 and 2 and the interactive operations 3 and 4, different preset areas are respectively set for presentation, and the following presentation effect of the interaction information in the unviewed status on the multimedia content presentation page is provided based on the situation of sorting in the same time sequence.

For example, for the interactive operations 1 and 2, if a comment “Master photographer” posted by an interaction object “Tear_Streaming” is in the unviewed status, interaction information corresponding to the interaction object “Tears_Streaming” is presented at a preset position corresponding to the unviewed status on the multimedia content presentation page shown in FIG. 18B.

For example, for the interaction operations 3 and 4, if an indirect interaction object “Little_White_Bunny” exists, who publishes a comment “Yes” for the comment “Master photographer” published by the interaction object “Tears_Streaming”, interaction information obtained by combining the indirect interaction object “Tears_Streaming” and the interaction object “Little_White_Bunny” in a preset combination manner is presented at a preset position corresponding to the unviewed status on the multimedia content presentation page as shown in FIG. 18C.

In this embodiment of the present disclosure, after the multimedia content presentation page is presented, in response to a trigger operation performed by the target object on the target multimedia content again, the interaction information of which the status tag is the unviewed status is rendered, when the target object performs the previous trigger operation on the target multimedia content, in the viewed status.

Interaction information that changes from the unviewed status to the viewed status and other interaction information that is in the viewed status are uniformly arranged and presented in a presentation manner for interaction information in the viewed status. Details are not described in the present disclosure again.

In this embodiment of the present disclosure, if the target object is used as an interaction object, and a commenting operation is performed on the target multimedia content, in response to the commenting operation performed by the target object on the target multimedia content, after the target object inputs association information, a virtual figure of the target object and interaction content corresponding to the target object are presented. The interaction content includes account presentation information of a related object of the association information.

The association information may be “@the related object”, where the related object may be any object.

In this embodiment of the present disclosure, the account presentation information may include an account profile photo corresponding to the related object.

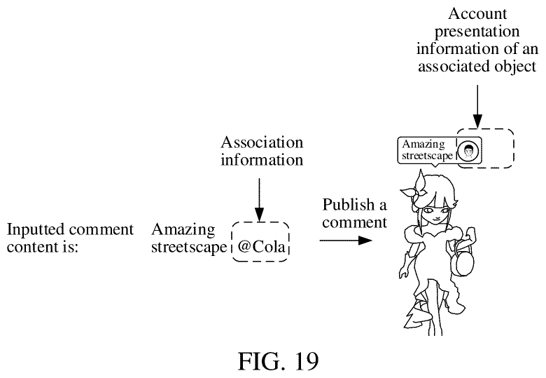

For example, the target object is “Bubble_N_Bubble”, “Bubble_N_Bubble” performs the commenting operation on the target multimedia content, and inputted comment content is “Amazing streetscape @Cola”, as shown in FIG. 19. The association information is “@Cola”. In this case, after the target object publishes the comment content, a virtual figure of the target object and interaction content corresponding to the target object are presented. The interaction content includes an account profile photo of a related object “Cola” of the association information.

During implementation, the client may filter out the association information, determine account information of a related object corresponding to the association information, and determine, based on the account information, an account profile photo corresponding to the related object.

In this embodiment of the present disclosure, the client may request an account profile photo corresponding to a related object from the server based on account information of the related object.

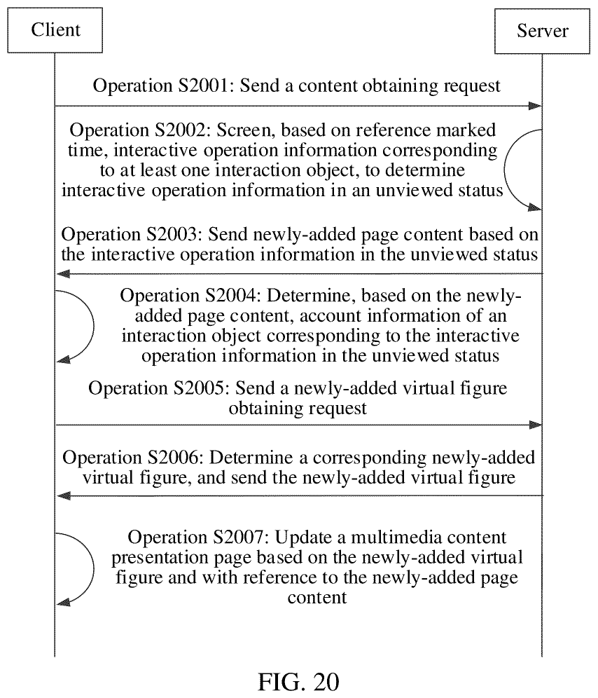

FIG. 20 is a flowchart of determining interaction information in an unviewed status according to an embodiment of the present disclosure. Specific operations are as follows:

Operation S2001: A client sends a content obtaining request to a server.

In this embodiment of the present disclosure, the content obtaining request includes identification information corresponding to the target multimedia content.

Operation S2002: The server screens, based on reference marked time, interactive operation information corresponding to at least one interaction object, to determine interactive operation information in an unviewed status.

The reference marked time is time when the target object triggers an operation for the target multimedia content last time.

In this embodiment of the present disclosure, based on the reference marked time, interaction time corresponding to the at least one interaction object performing the interactive operation on the target multimedia content is compared, to determine interaction time greater than the reference marked time, and to obtain screened interactive operation information corresponding to at least one interaction object. The screened interactive operation information corresponding to at least one interaction object is used as interactive operation information in the unviewed status.

The interaction time is time when the interaction object triggers the interactive operation on the target multimedia content. The triggered interactive operation includes any one of the interactive operations 1 to 4.

Operation S2003: Send newly-added page content to the client based on the interactive operation information in the unviewed status.

The newly-added page content includes the interactive operation information in the unviewed status.

Operation S2004: The client determines, based on the newly-added page content, account information of an interaction object corresponding to the interactive operation information in the unviewed status.

The interactive operation information in the unviewed status includes the account information of the interaction object corresponding to the interactive operation information in the unviewed status.

Operation S2005: The client sends a newly-added virtual figure obtaining request to the server.

In this embodiment of the present disclosure, the newly-added virtual figure obtaining request includes the account information of the interaction object corresponding to the interactive operation information in the unviewed status.

Operation S2006: The server determines a corresponding newly-added virtual figure, and sends the newly-added virtual figure to the client.

In this embodiment of the present disclosure, the newly-added virtual figure may include a virtual figure link corresponding to at least one interaction object corresponding to the interactive operation information in the unviewed status.

The interaction object corresponding to the interactive operation information in the unviewed status is associated with the target multimedia content.

Operation S2007: The client updates the multimedia content presentation page based on the newly-added virtual figure and with reference to the newly-added page content.

The updated multimedia content presentation page includes the interaction information in the unviewed status.

For example, the interaction information in the unviewed status may be arranged and presented in a preset area (the preset area is located in the interaction area of the target multimedia content) of the multimedia content presentation page from right to left based on a time sequence when a corresponding interaction object triggers the interactive operation.

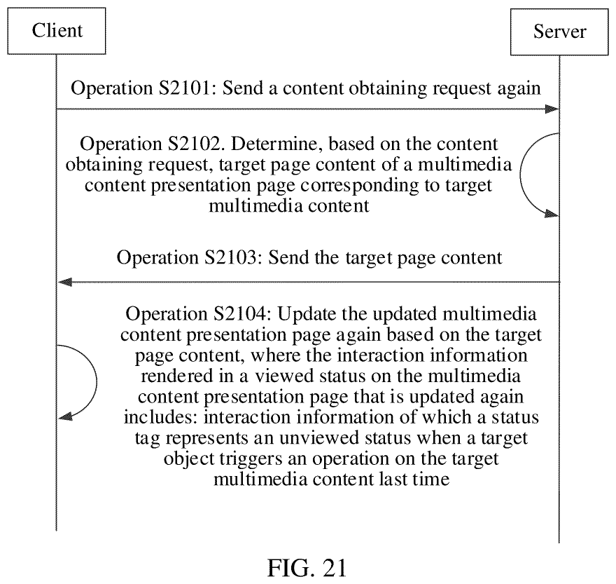

FIG. 21 is a flowchart of rendering an unviewed status to a viewed status according to an embodiment of the present disclosure. Specific operations are as follows:

Operation S2101: The client sends the content obtaining request to the server again.

The content obtaining request includes identification information corresponding to the target multimedia content.

Operation S2102: The server determines, based on the content obtaining request, target page content of the multimedia content presentation page corresponding to the target multimedia content.

The target page content includes the interactive operation information in the unviewed status when the operation is triggered for the target multimedia content last time.

Operation S2103: The server sends the target page content to the client.

Operation S2104: The client updates the updated multimedia content presentation page again based on the target page content. The interaction information rendered in the viewed status on the multimedia content presentation page that is updated again includes: the interaction information of which the status tag represents the unviewed status when the target object triggers an operation on the target multimedia content last time.

In this case, after the multimedia content presentation page is presented, this embodiment of the present disclosure further includes: rendering, in response to a trigger operation performed by the target object on the target multimedia content again, the interaction information of which the status tag is the unviewed status when the target object performs the previous trigger operation on the target multimedia content, in the viewed status.

In this embodiment of the present disclosure, for the interaction information of which the status tag represents the unviewed status when the operation is triggered for the target multimedia content last time, the interaction information is rendered in the viewed status when the target object triggers an operation for the target multimedia content next time.

During implementation, for the interaction information in the unviewed status as shown in FIG. 18A, FIG. 18B, and FIG. 18C, when the target object triggers an operation on the target multimedia content again, the interaction information presented in the corresponding figure and in the unviewed status may be rendered in the viewed status.

For example, when the operation is triggered for the target multimedia content last time, the interaction information in the unviewed status and the interaction information in the viewed status may be arranged and presented in a preset presentation area corresponding to the viewed status from left to right based on interaction time.

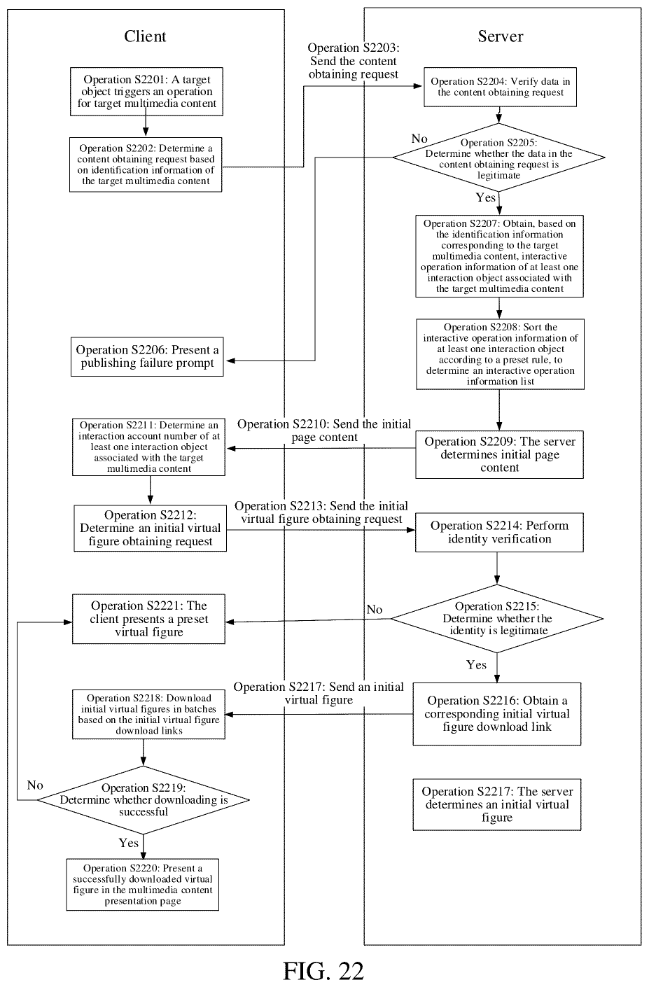

FIG. 22 is a whole flowchart of rendering a multimedia content presentation page according to an embodiment of the present disclosure. Specific operations are as follows:

Operation S2201: A target object triggers an operation for target multimedia content.

In some embodiments, the target object taps on the target multimedia content, to trigger a viewing operation on the target multimedia content.

Operation S2202: The client determines a content obtaining request based on identification information of the target multimedia content.

Operation S2203: The client sends the content obtaining request to a server.

Operation S2204: The server verifies data in the content obtaining request.

Operation S2205: The server determines whether the data in the content obtaining request is legitimate; if yes, perform operation S2207; if not, perform operation S2206.

Operation S2206: The client presents a publishing failure prompt.

Operation S2207: The server obtains, based on the identification information corresponding to the target multimedia content, interactive operation information of at least one interaction object associated with the target multimedia content.

In some embodiments, the server may alternatively obtain basic information of the target multimedia content based on the identification information corresponding to the target multimedia content.

In this embodiment of the present disclosure, the server stores a mapping relationship between the identification information of the target multimedia content and identification information of the interactive operation information of at least one interaction object performing the interactive operation on the target multimedia content. In this case, the interactive operation information of at least one interaction object performing the interactive operation on the target multimedia content may be determined based on the identification information of the target multimedia content.

The interactive operation information may include: a type of the interactive operation, account information of an interaction object triggering the interactive operation, comment content, and time when the interaction object triggers the interactive operation.

Operation S2208: The server sorts the interactive operation information of at least one interaction object according to a preset rule, to determine an interactive operation information list.

In some embodiments, the preset rule may be sorting based on interaction time corresponding to interaction objects in chronological order.

Operation S2209: The server determines initial page content.

In some embodiments, the server may determine the initial page content based on the basic information of the target multimedia content and the interactive operation information list corresponding to the target multimedia content.

Operation S2210: The client sends the initial page content to the server.

Operation S2211: The client determines an interaction account number of at least one interaction object associated with the target multimedia content.

In this embodiment of the present disclosure, the interaction account number of at least one interaction object performing the interactive operation on the target multimedia content may be determined based on the interactive operation information list in page content information.

Operation S2212: The client determines an initial virtual figure obtaining request.

In this embodiment of the present disclosure, the initial virtual figure obtaining request is determined based on the interaction account number of at least one interaction object.

The initial virtual figure obtaining request may be an assembled virtual figure request download link package.

Operation S2213: The client sends the initial virtual figure obtaining request to the server.

Operation S2214: The server performs identity verification.

Operation S2215: The server determines whether the identity is legitimate; if yes, perform operation S2216; if not, perform operation S2221.

Operation S2216: The server obtains a corresponding initial virtual figure download link.

In this embodiment of the present disclosure, the corresponding virtual figure download link is obtained based on the interaction account number of at least one interaction object.

Operation S2217: The server sends an initial virtual figure to the client.

In this embodiment of the present disclosure, the initial virtual figure is determined based on the obtained virtual figure download link corresponding to at least one interaction object.

The initial virtual figure may be an assembled virtual figure download link request return package.

Operation S2218: The client downloads initial virtual figures in batches based on download links of the initial virtual figures.

In this embodiment of this application, the virtual figures are downloaded in batches based on the virtual figure download links in the return package.

Operation S2219: The client determines whether downloading is successful; if yes, perform operation S2222; if not, perform operation S2221.

Operation S2220: The client presents a successfully downloaded virtual figure in an interaction area of the target multimedia content.

Operation S2221: The client presents a preset virtual figure in the interaction area of the target multimedia content.

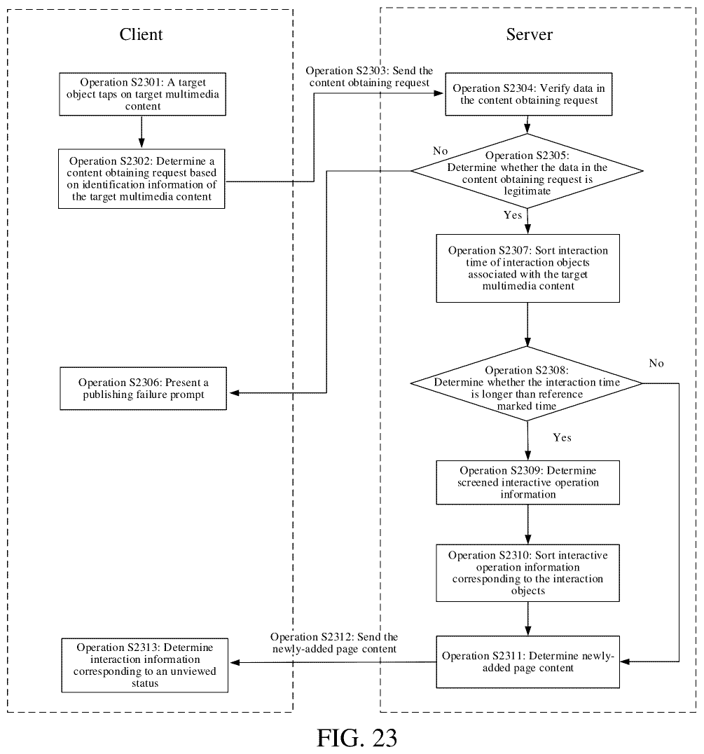

For interaction information in the unviewed status and presented on the multimedia content presentation page, this embodiment of the present disclosure provides a flowchart of determining interaction information in the unviewed status shown in FIG. 23. Specific operations are as follows:

Operation S2301: A target object taps on target multimedia content.

Operation S2302: A client determines a content obtaining request based on identification information of the target multimedia content.

Operation S2303: The client sends the content obtaining request to a server.

Operation S2304: The server verifies data in the content obtaining request.

Operation S2305: The server determines whether the data in the content obtaining request is legitimate; if yes, perform operation 2307; if not, perform operation S2306.

Operation S2306: The client presents a publishing failure prompt.

Operation S2301 to operation S2306 are same operations as operation S2201 to operation S2206 in FIG. 22.

Operation S2307: The server sorts interaction time of interaction objects associated with the target multimedia content.

Operation S2308: Determine whether the interaction time is longer than reference marked time; if yes, perform operation S2309; if no, perform operation S2311.

Operation S2309: Determine screened interactive operation information.

Operation S2310: Sort interactive operation information corresponding to the interaction objects.

In some embodiments, the interaction time may be sorted in descending order.

In this embodiment of the present disclosure, an interactive operation information list may be determined based on the sorted interactive operation information.

In some embodiments, the interactive operation information list may further include interaction information in the viewed status.

In this embodiment of the present disclosure, in the interactive operation information list, an order of the screened interactive operation information may be sorted ahead of an arrangement order of interactive operation information corresponding to the interaction information in the viewed status.

Operation S2311: Determine newly-added page content.

In this embodiment of the present disclosure, the newly-added page content carries the determined interactive operation information list.

Operation S2312: The server sends the newly-added page content to the client.

Operation S2313: Determine interaction information corresponding to the unviewed status.

During implementation, the client sends a newly-added virtual figure obtaining request to the server based on the received newly-added page content, and presents the multimedia content presentation page based on a newly-added virtual figure replied by the server. For a method principle, refer to operation S2211 to operation S2220 in FIG. 22. Details are not described herein again in the present disclosure.

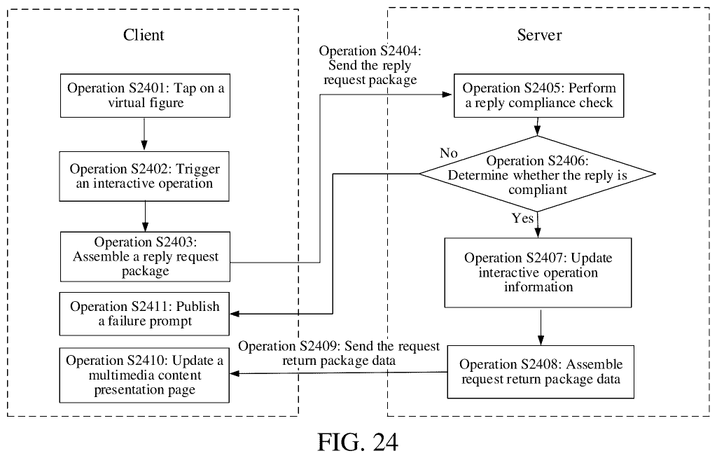

To perform an interactive operation on a target object, in this embodiment of the present disclosure, a flowchart of updating a multimedia content presentation page based on newly-added interactive operation information is shown in FIG. 24. Specific operations are as follows:

Operation S2401: Tap on a virtual figure.

Operation S2402: Trigger an interactive operation.

The interactive operation in this embodiment of the present disclosure may include at least one of the following: a thumbs-up operation and a commenting operation.

Operation S2403: Assemble a reply request package.

In this embodiment of this application, the reply request package includes interactive operation information corresponding to the interactive operation, for example, thumbs-up operation information corresponding to the thumbs-up operation, or commenting operation information corresponding to the commenting operation.

Operation S2404: A client sends the reply request package to a server.

Operation S2405: The server performs a reply compliance check.

In this embodiment of the present disclosure, the compliance check may be checking whether a target object has authorization to trigger the interactive operation.

Operation S2406: The server determines whether the reply is compliant; if yes, perform operation S2407; if not, perform operation S2411.

Operation S2407: The server updates the interactive operation information.

In some embodiments, newly-added interactive operation information may be inserted into the interactive operation information list.

Updating the interactive operation information includes: updating a sequence of interactive operation information groups in the interactive operation information list, and data in the interactive operation information groups.

Operation S2408: The server assembles request return package data.

In this embodiment of the present disclosure, the request return package data includes an updated interactive operation information list.

Operation S2409: The server sends the request return package data to the client.

Operation S2410: The client updates the multimedia content presentation page.

In some embodiments, after receiving the request return package data, the client may obtain only the updated interactive operation information list, and update the multimedia content presentation page based on the updated interactive operation information list.

Operation S2411: Publish a failure prompt.

For ease of description, the foregoing parts are divided into modules based on functions. Certainly, during the implementation of the present disclosure, the functions of the modules may be implemented in the same piece of or more pieces of software or hardware.

A person skilled in the art can understand that the aspects of the present disclosure may be implemented as systems, methods, or program products. Therefore, the aspects of the present disclosure may be embodied in the following forms: a hardware-only implementation, a software-only implementation (including firmware, microcode, etc.), or an implementation using a combination of hardware and software, which may be collectively referred to herein as “circuit”, “module”, or “system”.

The specific manners of performing operations by the various modules of the apparatuses in the foregoing embodiments are described in detail in the embodiments related to the methods, and are not further described in detail herein.

Based on the same inventive concept, this embodiment of the present disclosure provides a page processing apparatus, and a problem-solving principle of the apparatus is similar to the methods of the foregoing embodiments. Therefore, for implementations of the apparatus, refer to the implementations of the foregoing methods, and repetitions are not described.

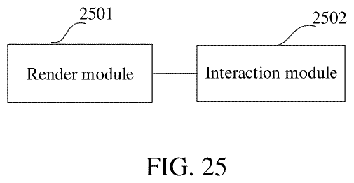

As shown in FIG. 25, this embodiment of the present disclosure provides a page processing apparatus 2500, including a render module 2501 and an interaction module 2502.

The render module 2501 is configured to generate and present a multimedia content presentation page in response to a trigger operation performed by a target object on multimedia content, the multimedia content presentation page including a presentation area and an interaction area of the multimedia content; and
the interaction module 2502 is configured to render, in the interaction area, interaction information of at least one interaction object performing an interactive operation on the multimedia content, interaction information of each interaction object including: a virtual figure of the interaction object, and interaction content generated by the interaction object by performing the interactive operation on the multimedia content, where the interaction content of the interaction object is presented within a peripheral preset range of the virtual figure of the interaction object.

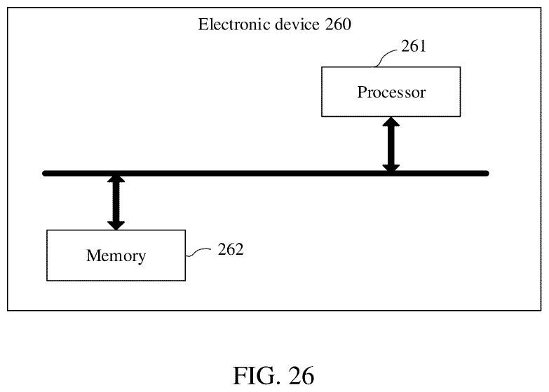

Referring to FIG. 26, an electronic device 260 may at least include a processor 261, and a memory 262. The memory 262 has program codes stored therein, and the program codes, when executed by the processor 261, cause the processor 261 to perform the operations performed by the client in the page processing method in the foregoing embodiments of the present disclosure.

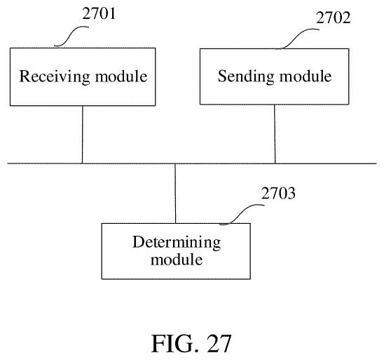

As shown in FIG. 27, this embodiment of the present disclosure provides a page processing apparatus 2700, including a receiving module 2701, a sending module 2702, and a determining module 2703.

The receiving module 2701 is configured to receive a content obtaining request sent by a client and determine initial page content of a multimedia content presentation page, the content obtaining request being sent when the client detects a trigger operation performed by a target object on multimedia content;
the sending module 2702 is configured to send the initial page content to the client; and

The determining module 2703 is configured to receive an initial virtual figure obtaining request replied by the client, determine a corresponding initial virtual figure, and send the corresponding initial virtual figure to the client, to make the client generate and present the multimedia content presentation page based on the initial virtual figure and with reference to the initial page content. The multimedia content presentation page includes: a presentation area and an interaction area of the multimedia content, and rendering, in the interaction area, interaction information of at least one interaction object performing an interactive operation on the multimedia content. Interaction information of each interaction object including: a virtual figure of the interaction object, and interaction content generated by the interaction object by performing the interactive operation on the multimedia content, where the interaction content of the interaction object is presented within a peripheral preset range of the virtual figure of the interaction object.

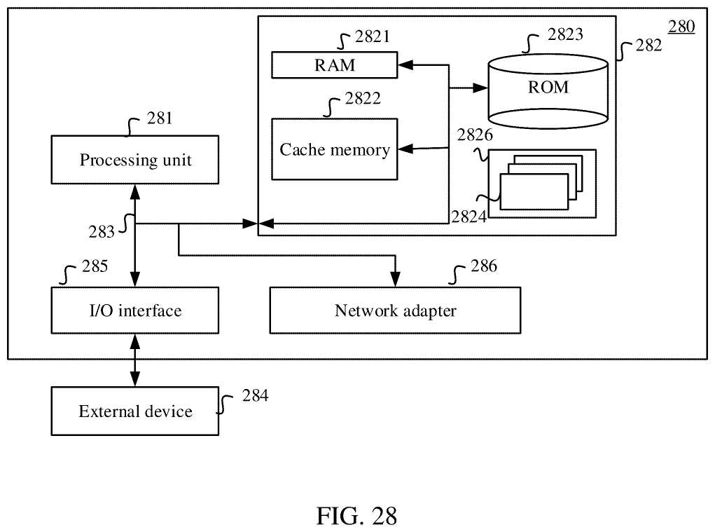

The following describes an electronic device 280 of this implementation of the present disclosure with reference to FIG. 28. The electronic device 280 shown in FIG. 28 is merely an example, and does not constitute any limitation on functions and usage scope of embodiments of the present disclosure.

As shown in FIG. 28, the electronic device 280 is represented in a form of a general-purpose electronic device. Components of the electronic device 280 may include, but are not limited to: at least one processing unit 281, at least one foregoing storage unit 282, and a bus 283 connecting different system components (including the storage unit 282 and the processing unit 281).

The bus 283 represents one or more of several types of bus structures, including a memory bus or a memory controller, a peripheral bus, a processor, or a local bus using any of a plurality of bus structures.

The storage unit 282 may include readable media in a form of a volatile memory, such as a random-access memory (RAM) 2821 and/or a cache memory 2822, and may further include a read-only memory (ROM) 2823.

The storage unit 282 may further include a program/utility 2826 having a set of (at least one) program modules 2824. Such program modules 2824 include, but are not limited to, an operating system, one or more applications, other program modules, and program data. Each of such examples or a combination thereof may include an implementation of a network environment.

The electronic device 280 may also communicate with one or more external devices 284 (for example, a keyboard or a pointing device), and may communicate with one or more devices that enable an object to interact with the electronic device 280, and/or may communicate with any device (for example, a router or a modem) that enables the electronic device 280 to communicate with one or more other computing devices. Such communication may be performed by using an input/output (I/O) interface 285. In addition, the electronic device 280 may further communicate with one or more networks (such as a local area network (LAN), a wide area network (WAN), and/or a public network (such as the Internet)) through a network adapter 286. As shown in the figure, the network adapter 286 communicates with other modules used on the electronic device 280 by using the bus 283. Although not shown in the figure, other hardware and/or software modules may be used in combination with the electronic device 280, including, but not limited to microcode, a device driver, a redundancy processor, an external disk drive array, a RAID system, a tape driver, a data backup and storage system, or the like.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

Based on the same inventive concept as the foregoing method embodiments, various aspects of the page processing method provided in the present disclosure can alternatively be implemented in a form of a program product, including program codes. When the program product is run on an electronic device, the program codes are configured for enabling the electronic device to execute the operations executed by the server in the page processing method according to various exemplary embodiments of this application in the foregoing description of this specification.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

In the present disclosure, portions of more than one embodiments or implementations may be combined to form another embodiment. For non-limiting example, a first portion or all of a first embodiment/implementation and a second portion or all of a second embodiment/implementation may be combined to form a third embodiment, wherein an order/sequence of the steps of the third embodiment may not be limited, and can be arranged to perform the functionalities of the third embodiment.

Although embodiments of this application have been described, persons skilled in the art can make changes and modifications to these embodiments once they learn the basic inventive concept. Therefore, the following claims are intended to cover the embodiments and all changes and modifications falling within the scope of this application.

Clearly, a person skilled in the art can make various modifications and variations to the present disclosure without departing from the spirit and scope of the present disclosure. In this case, if the modifications and variations made to the present disclosure fall within the scope of the claims of the present disclosure and equivalent technologies thereof, the present disclosure is intended to include these modifications and variations.

What is claimed is:

1. A method for processing a multimedia content presentation page, the method comprising:
generating and presenting, by a device comprising a memory and a process in communication with the memory, a multimedia content presentation page in response to a trigger operation performed by a target object on multimedia content, the multimedia content presentation page comprising a presentation area and an interaction area of the multimedia content; and
rendering, by the device in the interaction area, interaction information of at least one interaction object performing an interactive operation on the multimedia content,
wherein:
interaction information of each interaction object comprises: a virtual figure of the interaction object, and interaction content generated by the interaction object by performing the interactive operation on the multimedia content, and
the interaction content is presented within a peripheral preset range of the virtual figure of the interaction object.

2. The method according to claim 1, further comprising:
rendering, by the device, a status tag of the interaction information of the at least one interaction object on the multimedia content presentation page;
wherein: on the multimedia content presentation page, the status tag of the interaction information of the at least one interaction object is in an unviewed status or a viewed status.

3. The method according to claim 2, wherein after the rendering interaction information of at least one interaction object, the method further comprises:
in response to a trigger operation performed by the target object on the multimedia content again, rendering, by the device on the multimedia content presentation page, the interaction information of which the status tag represents the unviewed status when the target object performs the previous trigger operation on the multimedia content, in the viewed status.

4. The method according to claim 2, wherein when the status tag is the viewed status, the rendering interaction information of at least one interaction object comprises:
presenting, by the device in a preset viewed presentation area, by using a preset first arrangement manner, the interaction information of which the status tag is the viewed status, wherein the preset first arrangement manner is determined based on interaction time when the interaction object corresponding to the interaction information performs the interactive operation.

5. The method according to claim 2, wherein when the status tag is the unviewed status, the rendering interaction information of at least one interaction object comprises:
presenting, by the device in a preset unviewed presentation area, by using a preset second arrangement manner, the interaction information of which the status tag is the unviewed status, wherein the preset second arrangement manner is determined based on interaction time when the interaction object corresponding to the interaction information performs the interactive operation.

6. The method according to claim 1, wherein:
the interactive operation comprises at least one of the following:
a commenting operation performed by a corresponding interaction object on the multimedia content; or
a thumbs-up operation performed by a corresponding interaction object on the multimedia content; and
when the interaction area of the multimedia content is located within a peripheral range of the presentation area of the multimedia content, the rendering interaction information of at least one interaction object comprises:
rendering, by the device in the interaction area of the multimedia content, the interaction information of the at least one interaction object performing the interactive operation on the multimedia content.

7. The method according to claim 6, wherein:
the interactive operation comprises at least one of the following:
a commenting operation performed by a corresponding interaction object on an interaction result of the multimedia content; or
a thumbs-up operation performed by a corresponding interaction object on the interaction result of the multimedia content; and
the rendering interaction information of at least one interaction object comprises:
rendering, by the device using a preset combination manner, interaction information of each interaction object performing an interactive operation on the multimedia content, and interaction information of each interaction object performing an interactive operation on the interaction result of the multimedia content that are in the at least one interaction object.

8. The method according claim 7, wherein the interactive operation performed on the interaction result of the multimedia content comprises:
an interactive operation triggered on target interaction information in the interaction information of the at least one interaction object on the multimedia content presentation page.

9. The method according to claim 6, wherein after the presenting the multimedia content presentation page, the method further comprises:
presenting, by the device in response to a commenting operation performed by a target object on the multimedia content, after the target object inputs association information, a virtual figure of the target object and interaction content corresponding to the target object,
wherein the interaction content comprises account presentation information of a related object of the association information.

10. The method according to claim 1, wherein:
the multimedia content presentation page comprises the multimedia content and interaction information of at least one interaction object performing the interactive operation on the multimedia content; and
the presenting the multimedia content presentation page comprises:
sending, by the device, a content obtaining request to a server, the content obtaining request comprising identification information corresponding to the multimedia content;
receiving, by the device, initial page content replied by the server, the initial page content comprising interactive operation information corresponding to at least one interaction object performing the interactive operation on the multimedia content, and the interactive operation information comprising account information of the corresponding interaction object;
determining, by the device based on the initial page content, account information of the at least one interaction object, and sending a request for obtaining an initial virtual figure to the server based on at least one piece of obtained account information; and
receiving, by the device, the initial virtual figure from the server, and generating and presenting the multimedia content presentation page based on the initial virtual figure and with reference to the initial page content.

11. The method according to claim 3, wherein the interaction information on the multimedia content presentation page of which the status tag represents the unviewed status is determined based on the following manner:
receiving, by the device, newly-added page content from a server, the newly-added page content comprising interactive operation information in the unviewed status, the interactive operation information comprising account information of a corresponding interaction object, the interactive operation information in the unviewed status being determined by screening, based on reference marked time when the server receives a content obtaining request, interactive operation information corresponding to the at least one interaction object, and the reference marked time being time when the target object performs the trigger operation on the multimedia content last time;
determining, by the device based on the newly-added page content, the account information of the corresponding interaction object in the interactive operation information in the unviewed status, and sending a request for obtaining a newly-added virtual figure to the server based on the determined account information; and
receiving, by the device, the newly-added virtual figure from the server, and updating the multimedia content presentation page based on the newly-added virtual figure and with reference to the newly-added page content, the updated multimedia content presentation page comprising the interaction information in the unviewed status.

12. The method according to claim 11, wherein the rendering, the interaction information of which the status tag represents the unviewed status when the target object performs the previous trigger operation on the multimedia content, in the viewed status comprises:
sending, by the device, the content obtaining request to the server again, the content obtaining request carrying identification information corresponding to the multimedia content;
receiving, by the device, target page content from the server, the target page content comprising: interactive operation information corresponding to the interaction information of which the status tag is the viewed status in the interaction information in the unviewed status when the target object performs the previous trigger operation on the multimedia content; and
updating, by the device, the updated multimedia content presentation page again based on the target page content, wherein the interaction information rendered in the viewed status on the multimedia content presentation page that is updated again comprises: the interaction information of which the status tag represents the unviewed status when the target object triggers a viewing operation on the target multimedia content last time.

13. An apparatus for processing a multimedia content presentation page, the apparatus comprising:
a memory storing instructions; and
a processor in communication with the memory, wherein, when the processor executes the instructions, the processor is configured to cause the apparatus to perform:
generating and presenting a multimedia content presentation page in response to a trigger operation performed by a target object on multimedia content, the multimedia content presentation page comprising a presentation area and an interaction area of the multimedia content; and
rendering, in the interaction area, interaction information of at least one interaction object performing an interactive operation on the multimedia content,
wherein:
interaction information of each interaction object comprises: a virtual figure of the interaction object, and interaction content generated by the interaction object by performing the interactive operation on the multimedia content, and
the interaction content is presented within a peripheral preset range of the virtual figure of the interaction object.

14. The apparatus according to claim 13, wherein, when the processor executes the instructions, the processor is configured to further cause the apparatus to perform:
rendering a status tag of the interaction information of the at least one interaction object on the multimedia content presentation page;
wherein: on the multimedia content presentation page, the status tag of the interaction information of the at least one interaction object is in an unviewed status or a viewed status.

15. The apparatus according to claim 14, wherein, after the processor is configured to cause the apparatus to perform rendering interaction information of at least one interaction object, the processor is configured to further cause the apparatus to perform:
in response to a trigger operation performed by the target object on the multimedia content again, rendering, on the multimedia content presentation page, the interaction information of which the status tag represents the unviewed status when the target object performs the previous trigger operation on the multimedia content, in the viewed status.

16. The apparatus according to claim 14, wherein, when the status tag is the viewed status and when the processor is configured to cause the apparatus to perform rendering interaction information of at least one interaction object, the processor is configured to cause the apparatus to perform:
presenting, in a preset viewed presentation area, by using a preset first arrangement manner, the interaction information of which the status tag is the viewed status, wherein the preset first arrangement manner is determined based on interaction time when the interaction object corresponding to the interaction information performs the interactive operation.

17. The apparatus according to claim 14, wherein, when the status tag is the unviewed status and when the processor is configured to cause the apparatus to perform rendering interaction information of at least one interaction object, the processor is configured to cause the apparatus to perform:
presenting, in a preset unviewed presentation area, by using a preset second arrangement manner, the interaction information of which the status tag is the unviewed status, wherein the preset second arrangement manner is determined based on interaction time when the interaction object corresponding to the interaction information performs the interactive operation.

18. The apparatus according to claim 13, wherein:
the interactive operation comprises at least one of the following:
a commenting operation performed by a corresponding interaction object on the multimedia content; or
a thumbs-up operation performed by a corresponding interaction object on the multimedia content; and
when the interaction area of the multimedia content is located within a peripheral range of the presentation area of the multimedia content and when the processor is configured to cause the apparatus to perform rendering interaction information of at least one interaction object, the processor is configured to cause the apparatus to perform:
rendering, in the interaction area of the multimedia content, the interaction information of the at least one interaction object performing the interactive operation on the multimedia content.

19. The apparatus according to claim 13, wherein:
the multimedia content presentation page comprises the multimedia content and interaction information of at least one interaction object performing the interactive operation on the multimedia content; and
when the processor is configured to cause the apparatus to perform presenting the multimedia content presentation page, the processor is configured to cause the apparatus to perform:
sending a content obtaining request to a server, the content obtaining request comprising identification information corresponding to the multimedia content;
receiving initial page content replied by the server, the initial page content comprising interactive operation information corresponding to at least one interaction object performing the interactive operation on the multimedia content, and the interactive operation information comprising account information of the corresponding interaction object;
determining, based on the initial page content, account information of the at least one interaction object, and sending a request for obtaining an initial virtual figure to the server based on at least one piece of obtained account information; and
receiving the initial virtual figure from the server, and generating and presenting the multimedia content presentation page based on the initial virtual figure and with reference to the initial page content.

20. A non-transitory computer-readable storage medium, storing computer-readable instructions, wherein, the computer-readable instructions, when executed by a processor, are configured to cause the processor to perform:
generating and presenting a multimedia content presentation page in response to a trigger operation performed by a target object on multimedia content, the multimedia content presentation page comprising a presentation area and an interaction area of the multimedia content; and
rendering, in the interaction area, interaction information of at least one interaction object performing an interactive operation on the multimedia content, wherein:
interaction information of each interaction object comprises: a virtual figure of the interaction object, and interaction content generated by the interaction object by performing the interactive operation on the multimedia content, and
the interaction content is presented within a peripheral preset range of the virtual figure of the interaction object.
